(19) United States
(12) Patent Application Publication
(10) Pub. No.: US 2016/0267730 A1
(43) Pub. Date: Sep. 15, 2016

(54) SmartKey Apparatuses, Methods and Systems

(71) Applicants: Romesh Wadhwani, Los Altos Hills, CA (US); Kyle Francis Walworth, Ann Arbor, MI (US); Mark Douglas Searle, Wokingham (GB)

(72) Inventors: Romesh Wadhwani, Los Altos Hills, CA (US); Kyle Francis Walworth, Ann Arbor, MI (US); Mark Douglas Searle, Wokingham (GB)

(21) Appl. No.: 14/967,294

(22) Filed: Dec. 12, 2015

Related U.S. Application Data
(60) Provisional application No. 62/091,267, filed on Dec. 12, 2014.

(51) Int. Cl. G07C 9/00; G06F 21/32; G06F 21/35

(52) U.S. Cl. CPC G07C 9/00087; G06F 21/35; G06F 21/32; G07C 2009/00095; G07C 2009/00984

(57) ABSTRACT

The SmartKey Apparatuses, Methods and Systems (“SmartKey”) transforms start SmartKey app, login authentication, pair OEM, passcode, add record trigger, refresh record request, poll for SmartKey, update settings request, etc. inputs via SmartKey components into handle record, save device settings update, register SmartKey with OEM, register SmartKey with key server, etc. outputs. In one embodiment, the SmartKey has a smart key housing containing: a memory, a processor disposed in communication with the memory, a touch screen disposed in communication with the processor for display of smart key interaction with devices associated by device ID, a sensor array disposed in communication with the processor, at least one programmable context aware engageable input indicator disposed in communication with the processor, a connector disposed in communication with the processor and configured to communicate with outside devices, and a transceiver disposed in communication with the processor.

### PRIORITY CLAIM

Applicant hereby claims benefit to priority under 35 USC §119 as a non-provisional conversion] of: U.S. provisional patent application Ser. No. 62/091,267, filed Dec. 12, 2014, entitled “SmartKey Apparatuses, Methods and Systems,” (attorney docket no. Rwadhwani0001PV).

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address locking devices, and more particularly, include SmartKey Apparatuses, Methods and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Locks and keys allow users to both secure and access an area. Mechanical locks and keys have existed for ages and work on the principle of a key pattern mated to move tumblers so as to disengage a friction based obstruction to an area, and thereby unlock a lock. More recently, electronic locks have allowed users to use key cards and wireless electronic key fobs to engage the electronic locks, for example, in automobiles.

### BRIEF DESCRIPTION OF THE DRAWINGS

Appendices and/or drawings illustrating various, non-limiting, example, innovative aspects of the SmartKey Apparatuses, Methods and Systems (hereinafter “SmartKey”) disclosure, include:

FIG. 1 shows a block diagram illustrating fob embodiments of the SmartKey;

FIG. 2 shows a datagraph diagram illustrating embodiments of registration for the SmartKey;

FIGS. 3a-3b show a datagraph diagram illustrating embodiments of SmartKey and OEM domain association for the SmartKey;

FIGS. 4a-4b shows a datagraph diagram illustrating embodiments of service record adding/updating for the SmartKey;

FIG. 5 shows a datagraph diagram illustrating embodiments of device record and read for the SmartKey;

FIG. 6 shows a datagraph diagram illustrating embodiments of device record and update for the SmartKey;

FIG. 7 shows a datagraph diagram illustrating embodiments of a record router for the SmartKey;

FIG. 8 shows a block diagram illustrating embodiments of a SmartKey controller.

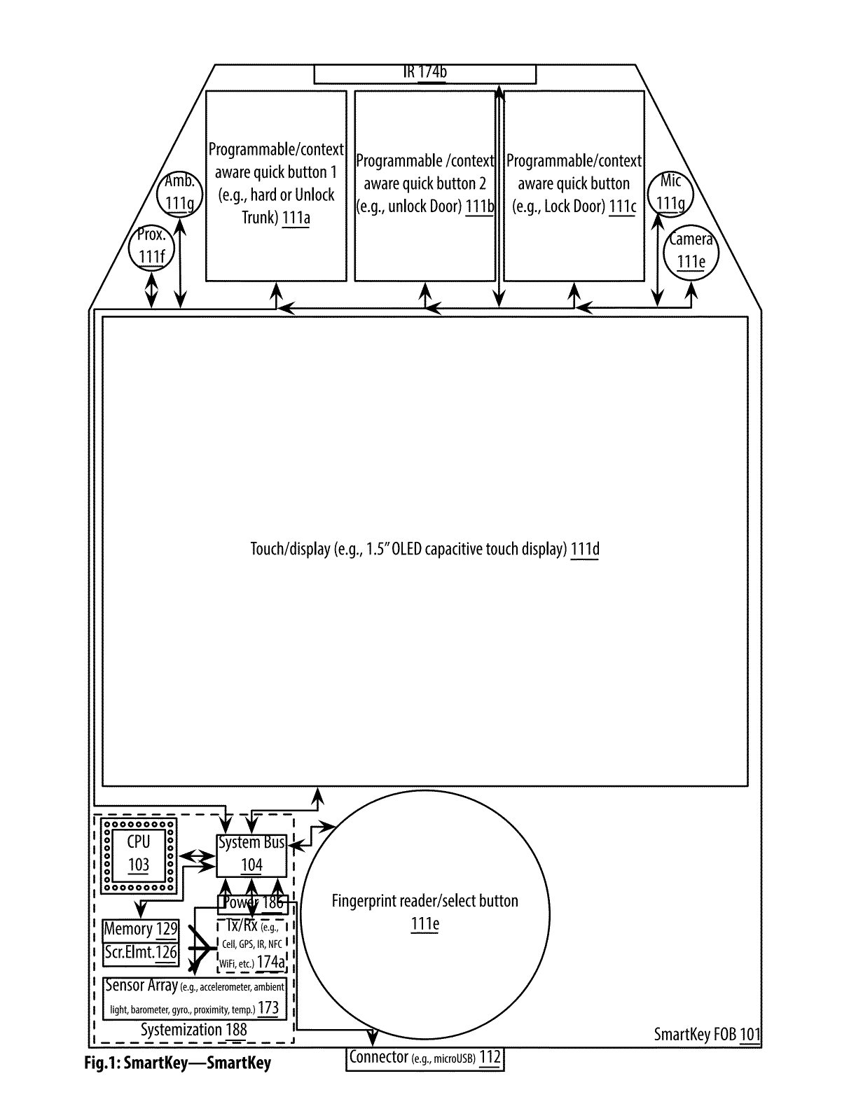

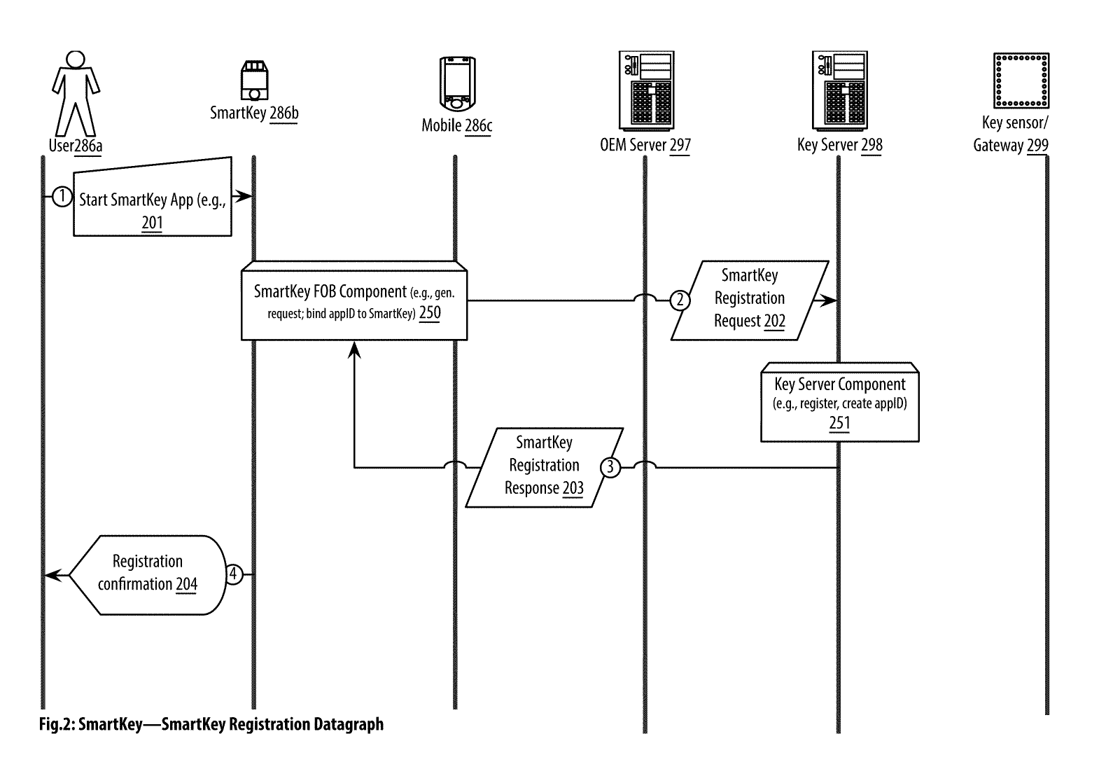

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citation and/or reference numbers are not necessarily sequences but rather just example orders that may be rearranged and other orders are contemplated.

### DETAILED DESCRIPTION

The SmartKey Apparatuses, Methods and Systems (hereinafter “SmartKey”) transforms start SmartKey app, login authentication, pair OEM, passcode, add record trigger, refresh record request, poll for SmartKey, update settings request, etc. inputs, via SmartKey components (e.g., SmartKey FOB 850, Key Server 851, OEM Key Server 852, Device 853, Settings App 854, etc., etc.), into handle record, save device settings update, register SmartKey with OEM, register SmartKey with key server, etc. outputs. The SmartKey components, in various embodiments, implement advantageous features as set forth below.

### SmartKey

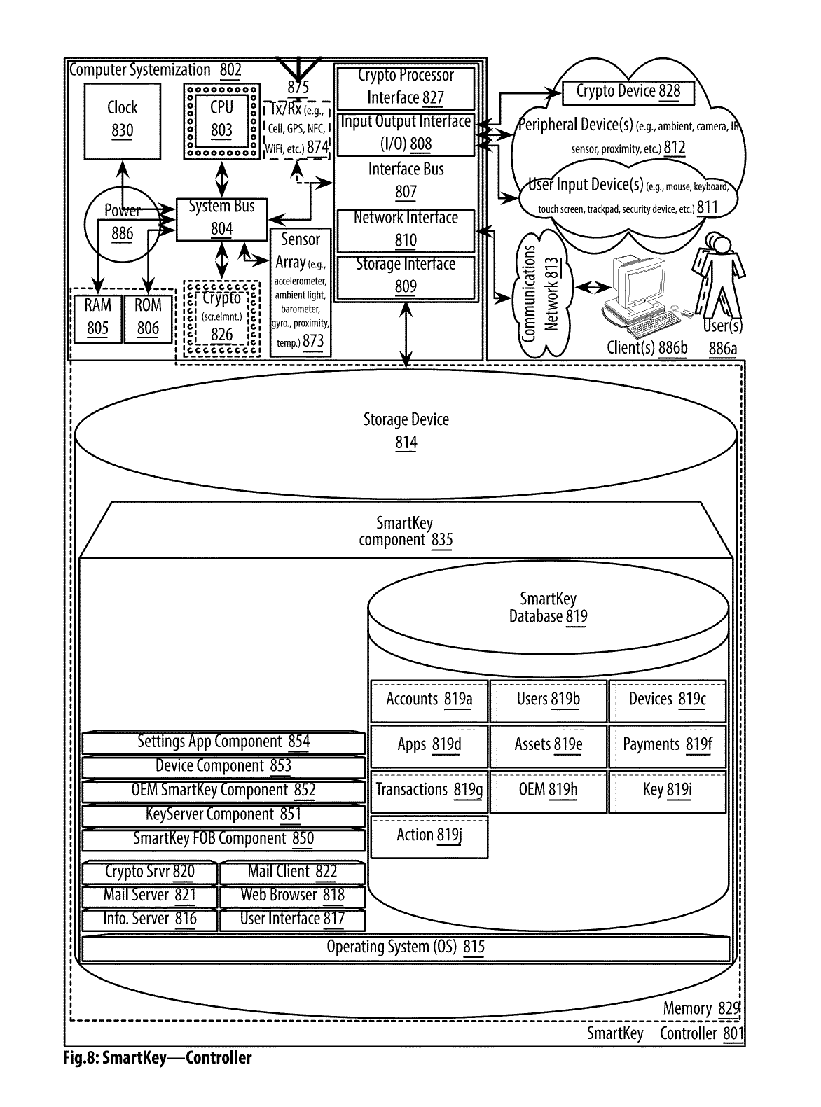

FIG. 1 shows a block diagram illustrating fob embodiments of the SmartKey. The example SmartKey fob 101 may include a systemization 188 (e.g., see FIG. 8 for greater detail). The systemization itself may include a CPU 103 disposed in communication with a system bus 104, and a power source 186. The system bus 104 may be interconnected to a number of peripherals such as memory 129, a secure element 126 (e.g., Infineon SLE 97 NFC IC), transceivers 174, sensor array 173, etc. Further, the system bus 104 may include communicate outside the systemization 188, but within the SmartKey fob housing, to additional peripheral devices interconnected with via a number of communicative conduit datapaths (e.g., USB connection) to a number of user peripheral devices (e.g., programmable context aware quick buttons—optionally the buttons may contain small OLED screens allowing the display of the changing button functions under different contexts) 111a-c, fingerprint reader/selection button 111e, an (e.g., ShenZhen New Display Co. OLED capacitive 1.5″ Model No. YX-2828GDEDF11) touch display, communication transceivers (e.g., wireless transceivers 174a, (micro) USB connector 112, infrared port 174b), and sensor array 173 (e.g., ambient 111g, proximity 111f, camera 111e, microphone 111h, etc.), and/or the like. SmartKey fob 101 may further employ components and/or take on the structure and/or be a variant of the SmartKey Controller of FIG. 8.

FIG. 2 shows a datagraph diagram illustrating embodiments of registration for the SmartKey. Initially a user may obtain a SmartKey fob (e.g., see FIGS. 1 and 8) having a SmartKey application/component. The user may engage 201 with the SmartKey fob 286b and cause the SmartKey application/component to instantiate 250 (e.g., pressing a button/touch screen (e.g., unlock vehicle feature). It should be noted that the SmartKey fob component may be instantiated on the SmartKey fob 286b itself, on a mobile device 286c itself, on the SmartKey fob 286b tethered to the mobile device 286c and acting as a relaying communications conduit for the SmartKey, on both devices where the components will take on server/client roles, and/or the like. Upon instantiation of the SmartKey fob component 250, it will generate SmartKey registration request 202 for a Key Server 298. It should also be noted, that in another embodiment, the SmartKey, itself could be implemented as a mobile SIM card application as SIM cards are another type of application environment; for example, in such an embodiment it could implemented in a device (e.g., phone, tablet, etc.) via the SIM card or as an external key. An example SmartKey Registration request 202, substantially in the form of a HTTP(S) POST message including XML-formatted data, is provided below:

```
POST /authrequest.php HTTP/1.1
Host: www.server.com
Content-Type: Application/XML
Content-Length: 667
<?XML version = “1.0” encoding = “UTF-8”?>
<SmartKeyRegistrationRequest>
    <timestamp>2020-12-31 23:59:59</timestamp>
    <user_accounts_details>
        <user_account_credentials>
            <user_name>JohnDaDoeDoeDoooe@gmail.com</
            account_name>
            <password>abc123</password>
            //OPTIONAL <cookie>cookieID</cookie>
            //OPTIONAL <digital_cert_link>
www.mydigitalcertificate.com/JohnDoeDaDoeDoe@gmail.com/
mycertifcate.dc</digital_cert_link>
            //OPTIONAL <digital_certificate>_DATA_</
            digital_certificate>
        </user_account_credentials>
    </user_accounts_details>
    <client_details> //Android Client with Webbrowser
        <client_IP>10.0.0.123</client_IP>
        <client_GPS>33.2, −96.7</client_GPS>
        <user_agent_string>Mozilla/5.0 (Linux; U; Android 4.0.4;
en-us; Nexus S Build/IMM76D) AppleWebKit/534.30 (KHTML, like
Gecko) Version/4.0 Mobile Safari/534.30</user_agent_string>
        <client_product_type>SmartKey</client_product_type>
        <client_product_OEM>GM</client_product_OEM>
        <client_product_OEM_model>Corvette</
        client_product_OEM_model>
        <client_OEM_serial_number>AXXXXXXXXC</
        client_OEM_serial_number>
        <VIN>VINXXXXX1234</VIN>
        <client_UDID>FXXXXXXXXX-XXXX-XXXX-XXXX-
        XXXXXXXXXXXXX</client_UDID>
        <client_OS>Android</client_OS>
        <client_OS_version>4.0.4</client_OS_version>
        <client_app_type>web browser</client_app_type>
        <client_name>Mobile Safari</client_name>
        <client_version>534.30</client_version>
        <context>carParkingLot</context>
        <buttonContextDisplay>
            <1>Locate Car</1>
            <2>Honk horn, flash lights</2>
            <3>Panic</3>
            <4>(Un)lock Doors</4>
            <5>(Un)lock trunk</5>
        </buttonContextDisplay>
    </client_details>
    <requestPayload>
        <credentials>SmartKeySecureElementPublicKey</credentials>
        <request>registerNewKey</request>
    </requestPayload>
</SmartKeyRegistrationRequest>
```

The Key Server 298 then uses the request 202 to register the SmartKey fob with itself by creating an application identifier (appID), e.g., via the Key Server component 251, and providing a SmartKey registration response 203 back to the SmartKey fob component 250. In one embodiment, unique identifiers are generated in sequence, while in another, they are randomized and checked to not be duplicates. The Key Server component may create, store/register the appID by updating its database; An exemplary listing, written substantially in the form of PHP/SQL commands, to update the key record in the SmartKey database, is provided below:

<?PHP
header(′Content-Type: text/plain′);
// store input data in a database
mysql_connect(″201.408.185.132″,$DBserver,$password); // access
database server
mysql_select(″SmartKey_DB.SQL″); // select database to append
mysql_query(“UPDATE keyTable
SET credentials = ‘SmartKeySecureElementPublicKey′ ,
request = ′requestNewKey′, appID = ‘123ABC456XYZ’,
timestamp = ′2013-02-22 15:22:43′
WHERE userID = ′JDoe@gmail.com′, smartKeyID = ’unqiueID’ ″);
mysql_close(″SmartKey_DB.SQL″); // close connection to database
?>

An example SmartKey Registration response 203, substantially in the form of a HTTP(S) POST message including XML-formatted data, is provided below:

```
POST /authrequest.php HTTP/1.1
Host: www.server.com
Content-Type: Application/XML
Content-Length: 667
<?XML version = “1.0” encoding = “UTF-8”?>
<SmartKeyRegistrationResponse>
  <timestamp>2020-12-31 23:59:59</timestamp>
  <responsePayload>
      <credentials>KeyServerPublicKey</credentials>
      //<login_credentials_user>username</login_credentials_user>
      //<login_credentials_password>password</
      login_credentials_password>
  </responsePayload>
</SmartKeyRegistrationResponse>
```

The SmartKey fob component 250 may then provide registration confirmation to 204 to the user 286a via display/notification message (e.g., “SmartKey registered successfully” displayed on the SmartKey 286b, mobile device 286c, email/text notification, and/or the like).

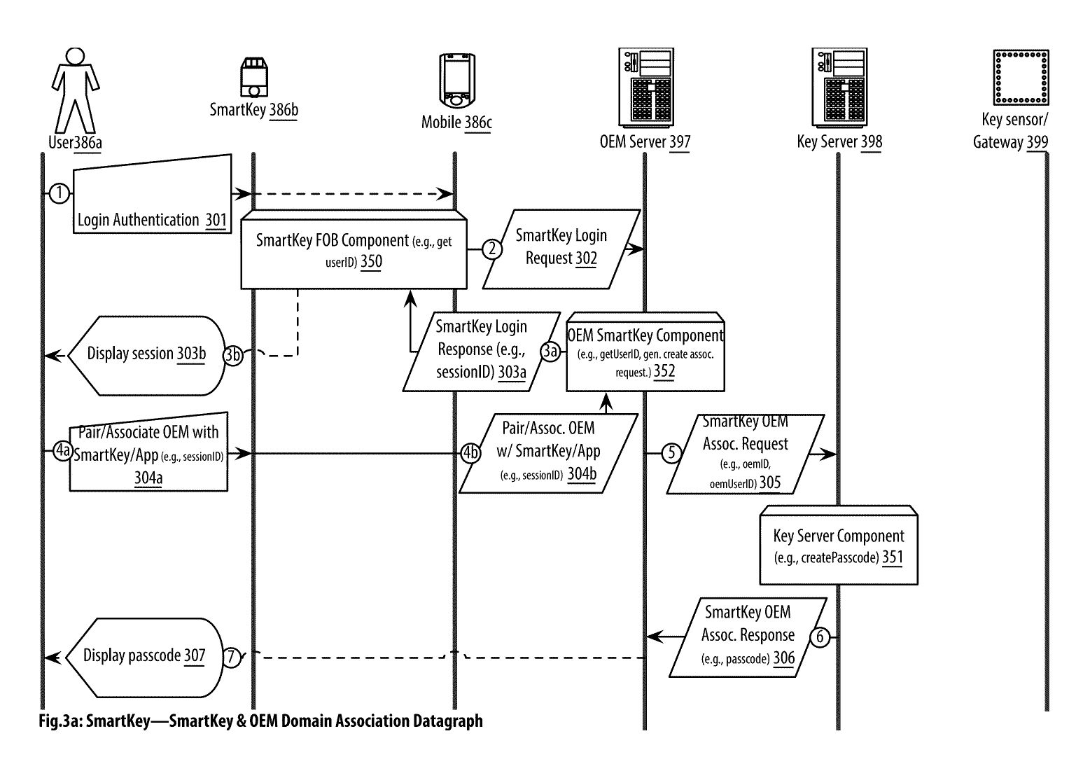

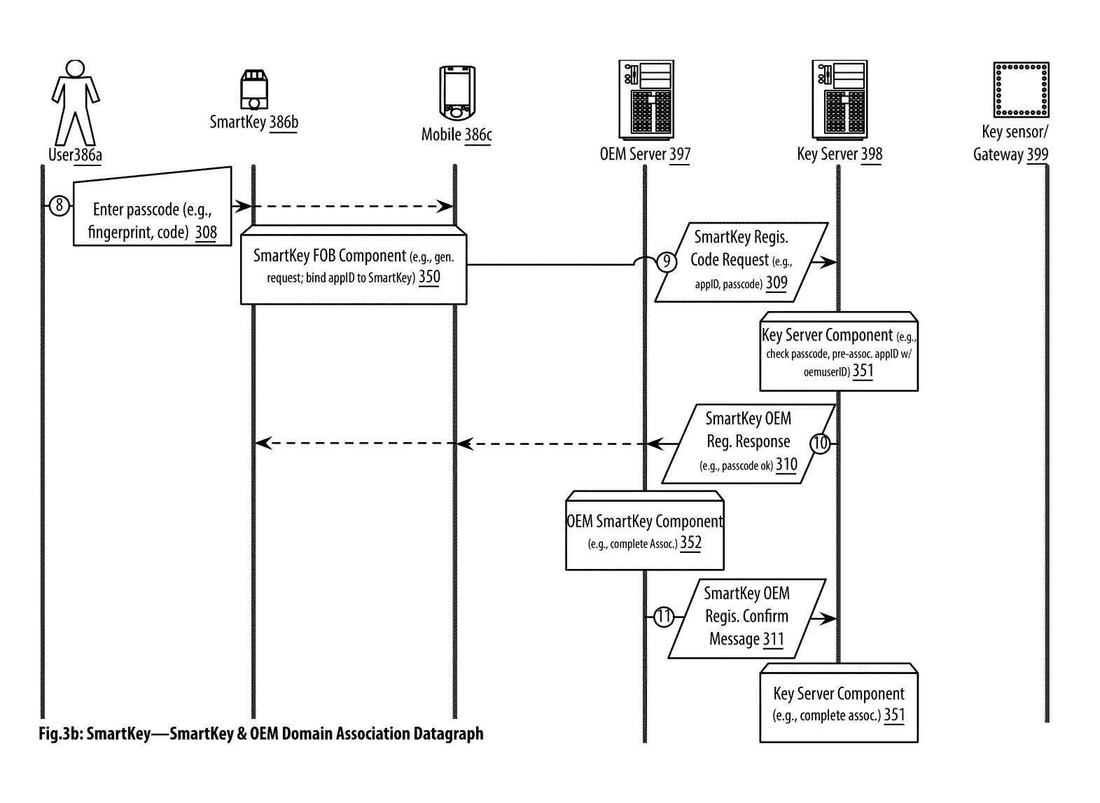

FIGS. 3a-3b show a datagraph diagram illustrating embodiments of SmartKey and original equipment manufacturer (OEM) domain association for the SmartKey. It should be noted that OEM participation regarding SmartKey usage may be desirable for various advanced features. For example, an OEM may wish to maintain greater control over SmartKeys and devices operable with SmartKeys and in some embodiments may combine KeyServer 398 features with OEM server 397 features (e.g., the KeyServer Component 351 may run on either and/or both servers). In other embodiments, Key server 398 may be separated to manage features among a number of OEMs and OEM servers. Regardless, OEMs may wish to provide added features to both the SmartKey and devices operable with SmartKeys, and as such, may provide an OEM server 397 to facilitate such additional feature sets, including any requisite security credentials. As such a user 386a (e.g., and end user, OEM representative, dealer, etc.) may provide login credentials 301 to a SmartKey fob 386b and/or mobile device 386b (e.g., user/password, biometric (e.g., fingerprint, etc.), accompanying digital certificate, etc.) to the SmartKey fob component 350. The SmartKey/mobile device 386b/c may then generate a SmartKey login request 302 and send it to the OEM server 387. An example SmartKey login request 302, substantially in the form of a HTTP(S) POST message including XML-formatted data, is provided below:

```
POST /authrequest.php HTTP/1.1
Host: www.server.com
Content-Type: Application/XML
Content-Length: 667
<?XML version = “1.0” encoding = “UTF-8”?>
<SmartKeyLoginRequest>
    <timestamp>2020-12-31 23:59:59</timestamp>
    <user_accounts_details>
        <user_account_credentials>
            <user_name>JohnDaDoeDoeDoooe@gmail.com</
            account_name>
            <password>abc123</password>
            //OPTIONAL <cookie>cookieID</cookie>
            //OPTIONAL <digital_cert_link>
www.mydigitalcertificate.com/JohnDoeDaDoeDoe@gmail.com/
mycertifcate.dc</digital_cert_link>
            //OPTIONAL <digital_certificate>_DATA_</
            digital_certificate>
            //OPTIONAL
<biometric_and_or_hash>_DATA_</
biometric_and_or_hash>
        </user_account_credentials>
    </user_accounts_details>
    <client_details> //Android Client with Webbrowser
        <client_IP>10.0.0.123</client_IP>
        <client_GPS>33.2, −96.7</client_GPS>
        <user_agent_string>Mozilla/5.0 (Linux; U; Android 4.0.4;
en-us; Nexus S Build/IMM76D) AppleWebKit/534.30 (KHTML, like
Gecko) Version/4.0 Mobile Safari/534.30</user_agent_string>
        <client_product_type>SmartKey</client_product_type>
        <client_product_OEM>GM</client_product_OEM>
        <client_product_OEM_model>Corvette</
        client_product_OEM_model>
        <client_OEM_serial_number>AXXXXXXXXC</
        client_OEM_serial_number>
        <client_serial_number>YXXXXXXXXZ</
        client_serial_number>
        <VIN>VINXXXXX1234</VIN>
        <client_UDID>FXXXXXXXXX-XXXX-XXXX-XXXX-
        XXXXXXXXXXXXX</client_UDID>
        <client_OS>Android</client_OS>
        <client_OS_version>4.0.4</client_OS_version>
        <client_app_type>web browser</client_app_type>
        <client_name>Mobile Safari</client_name>
        <client_version>534.30</client_version>
        <context>activate</context>
        <buttonContextDisplay>
            <1>Locate Car</1>
            <2>Honk horn, flash lights</2>
            <3>Panic</3>
            <4>(Un)lock Doors</4>
            <5>(Un)lock trunk</5>
        </buttonContextDisplay>
    </client_details>
    <loginPayload>
        <credentials>SmartKeySecureElementPublicKey</credentials>
        <credentials>KeyServerPublicKey</credentials>
        <appID>123ABC456XYZ</appID>
        <login_credentials_user>username</login_credentials_user>
        <login_credentials_password>password</
        login_credentials_password>
    </loginPayload>
</SmartKeyLoginRequest>
```

With the login request 302, the OEM server 397 may take the request and employ its OEM SmartKey Component to get the user's ID, generate and create associations between the userID and the OEM, an send back a SmartKey login response, including a sessionID 303a, which will allow the user 386a to obtain OEM display information 303b. For example, an OEM may limit key pairing for a limited amount of time while a session lasts, and with providing an OEM public key, keyed to the provided SmartKey public secure element. An example SmartKey login response 303a, substantially in the form of a HTTP(S) POST message including XML-formatted data, is provided below:

```
POST /authrequest.php HTTP/1.1
Host: www.OEMserver.com
Content-Type: Application/XML
Content-Length: 667
<?XML version = “1.0” encoding = “UTF-8”?>
<SmartKeyLoginResponse>
    <timestamp>2020-12-31 23:59:59</timestamp>
    <responsePayload>
    <credentials>OEMServerPublicKeyMatchedToSmartKeyPublic-
    Element</credentials>
        <sessionID>XYZ123</sessionID>
        <sessionToken>sessionTokenData</sessionToken>
        <sessionTimeOutSeconds>150</sessionTimeOutSeconds>
    </responsePayload>
</SmartKeyLoginResponse>
```

A user 386a may then provide an indication that they care to pair their SmartKey 386b with an OEM 304a. The OEM server 397 may obtain this indication to pair request 304b from the user 386a, 386b, 386c, and upon matching the SmartKey 386b secure element within the sessionID timeout constraints, the OEM SmartKey component 352 finally create the association and store it for future accesses by the user.

The OEM server may then send a SmartKey OEM Association request to the Key server 398 including the OEM ID and OEM UserID so the secure elements of both the SmartKey 386b and OEM Server may be associated together at the Key Server 398 for future access by either the SmartKey and/or the OEM server 305. An example SmartKey login response 305, substantially in the form of a HTTP(S) POST message including XML-formatted data, is provided below:

```
POST /authrequest.php HTTP/1.1
Host: www.OEMserver.com
Content-Type: Application/XML
Content-Length: 667
<?XML version = “1.0” encoding = “UTF-8”?>
<SmartKeyAssocRequest>
    <timestamp>2020-12-31 23:59:59</timestamp>
    <responsePayload>
        <OEMID>PublicKeyOEMSecureElementKey</OEMID>
    <OEMUserID>OEMServerPublicKeyMatchedToSmartKeyPublic-
    Element</OEMUserID>
        <UserID>SmartKeySecureElementPublicKey</UserID>
        <sessionID>XYZ123</sessionID>
        <sessionToken>sessionTokenData</sessionToken>
        <sessionTimeOutSeconds>150</sessionTimeOutSeconds>
    </responsePayload>
</SmartKeyAssocRequest>
```

The Key Server Component 351 may then generate a passcode related to both the OEM server 397 and the SmartKey 386b and provide a SmartKey OEM association response with the passcode 306 and store such association.

The KeyServer component may update 351 its database of the association; An exemplary listing, written substantially in the form of PHP/SQL commands, to update the key record in the SmartKey database, is provided below:

<?PHP
header(′Content-Type: text/plain′);
// store input data in a database
mysql_connect(″201.408.185.132″,$DBserver,$password); // access
database server
mysql_select(″SmartKey_DB.SQL″); // select database to append
mysql_query(“UPDATE SmartKeyTable
SET userID = ‘username′, sessionID = ′XYZ123′, sessionToken =
‘sessionTokenData’, smartKeyID = ‘keyUniqueID’, passcode =
‘uniqueCode’, timestamp = ′2013-02-22 15:22:43′
WHERE userID = ′JDoe@gmail.com′, smartKeyID = ‘keyUniqueID’ ″);
mysql_close(″SmartKey_DB.SQL″); // close connection to database
?>

The passcode may be provided for display 307 to the user 386a via user device 386b, 386c.

Moving to FIG. 3b, showing access of OEM 397 and Key Server 398 information with the SmartKey/device 386b 386c. The user 386a may enter the previously generated passcode (e.g., this may be an actual alphanumeric code, a fingerprint analogue for the code, etc.) 308 showing an indication to use a device locked/controlled by the SmartKey 386b (e.g., wanting to access a car locked and controlled by the Smartkey, indicate any number of features for the targeted locked device (e.g., turn on lights, horn, heat, open trunk, etc.)). Upon obtaining the passcode 308, the SmartKey FOB component may generate a SmartKey Registration Code Request 309 and provide it to the Key Server 398. An example SmartKey registration code request 309, substantially in the form of a HTTP(S) POST message including XML-formatted data, is provided below:

```
POST /authrequest.php HTTP/1.1
Host: www.server.com
Content-Type: Application/XML
Content-Length: 667
<?XML version = “1.0” encoding = “UTF-8”?>
<SmartKeyRegisCodeRequest>
    <timestamp>2020-12-31 23:59:59</timestamp>
    <user_accounts_details>
        <user_account_credentials>
            <user_name>JohnDaDoeDoeDoooe@gmail.com</
            account_name>
            <password>abc123</password>
            //OPTIONAL <cookie>cookieID</cookie>
            //OPTIONAL <digital_cert_link>
www.mydigitalcertificate.com/JohnDoeDaDoeDoe@gmail.com/
mycertifcate.dc</digital_cert_link>
            //OPTIONAL <digital_certificate>_DATA_</
            digital_certificate>
        </user_account_credentials>
    </user_accounts_details>
    <client_details> //Android Client with Webbrowser
        <client_IP>10.0.0.123</client_IP>
        <client_GPS>33.2, −96.7</client_GPS>
        <user_agent_string>Mozilla/5.0 (Linux; U; Android 4.0.4;
en-us; Nexus S Build/IMM76D) AppleWebKit/534.30 (KHTML, like
Gecko) Version/4.0 Mobile Safari/534.30</user_agent_string>
        <client_product_type>SmartKey</client_product_type>
        <client_product_OEM>GM</client_product_OEM>
        <client_product_OEM_model>Corvette</
        client_product_OEM_model>
        <client_OEM_serial_number>AXXXXXXXXC</
        client_OEM_serial_number>
        <client_serial_number>YXXXXXXXXZ</
        client_serial_number>
        <VIN>VINXXXXX1234</VIN>
        <client_UDID>FXXXXXXXXX-XXXX-XXXX-XXXX-
        XXXXXXXXXXXXX</client_UDID>
        <client_OS>Android</client_OS>
        <client_OS_version>4.0.4</client_OS_version>
        <client_app_type>web browser</client_app_type>
        <client_name>Mobile Safari</client_name>
        <client_version>534.30</client_version>
        <context>activate</context>
        <buttonContextDisplay>
            <1>Locate Car</1>
            <2>Honk horn, flash lights</2>
            <3>Panic</3>
            <4>(Un)lock Doors</4>
            <5>(Un)lock trunk</5>
        </buttonContextDisplay>
    </client_details>
    <loginPayload>
        <UserID>SmartKeySecureElementPublicKey</UserID>
        <appID>123ABC456XYZ</appID>
        <OEMID>PublicKeyOEMSecureElementKey</OEMID>
        <login_credentials_user>username</login_credentials_user>
        <login_credentials_password>password</
        login_credentials_password>
        <passcode>myPasscodeOrFingerprintCode</passcode>
    </loginPayload>
</SmartKeyRegisCodeRequest>
```

The Key Server's 398 Key Server Component 351 may then determine that the passcode and that an association with the appID and the OEMUserID exists. If it does exist, the Key Server Component may provide the SmartKey FOB Component with a Smartkey OEM Registration Response 310 message, i.e., that the passcode has been accepted 310. The OEM SmartKey Component then may complete the association between the appID and OEMUserID 352, and provide a confirmation message 311 to the Key Server's 398 Key Server Component 351, which in turn will complete the association between the appID and OEMUserID.

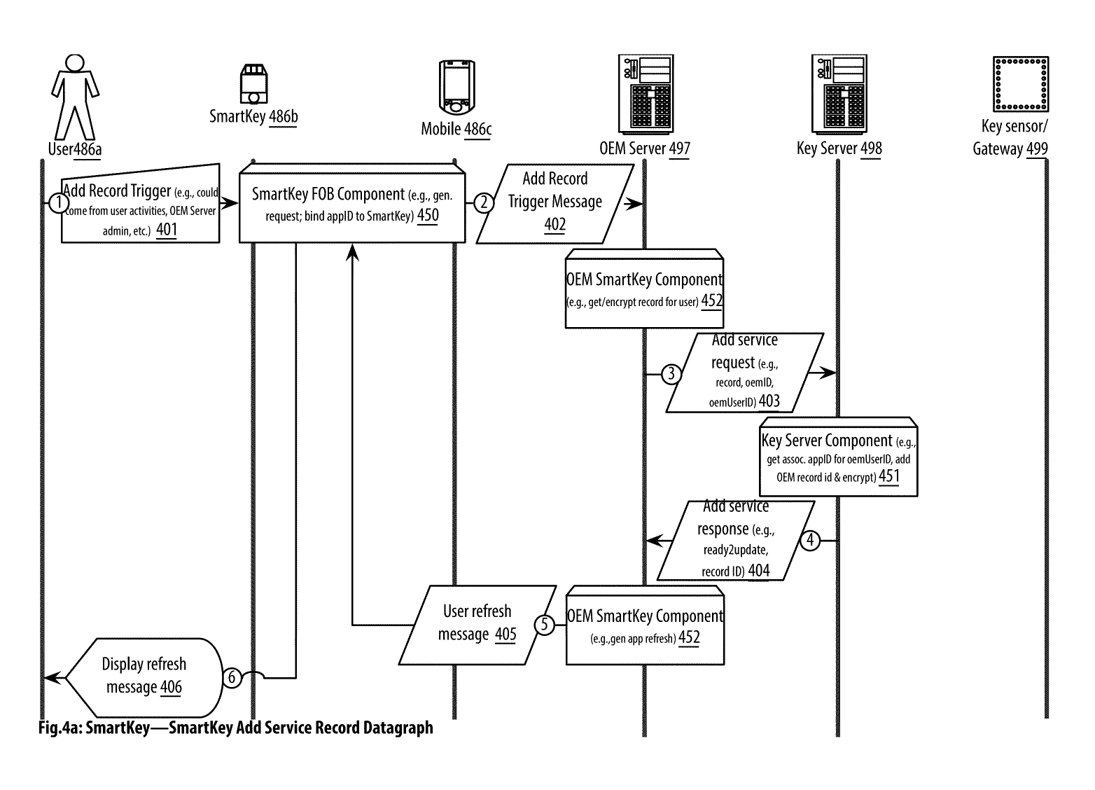

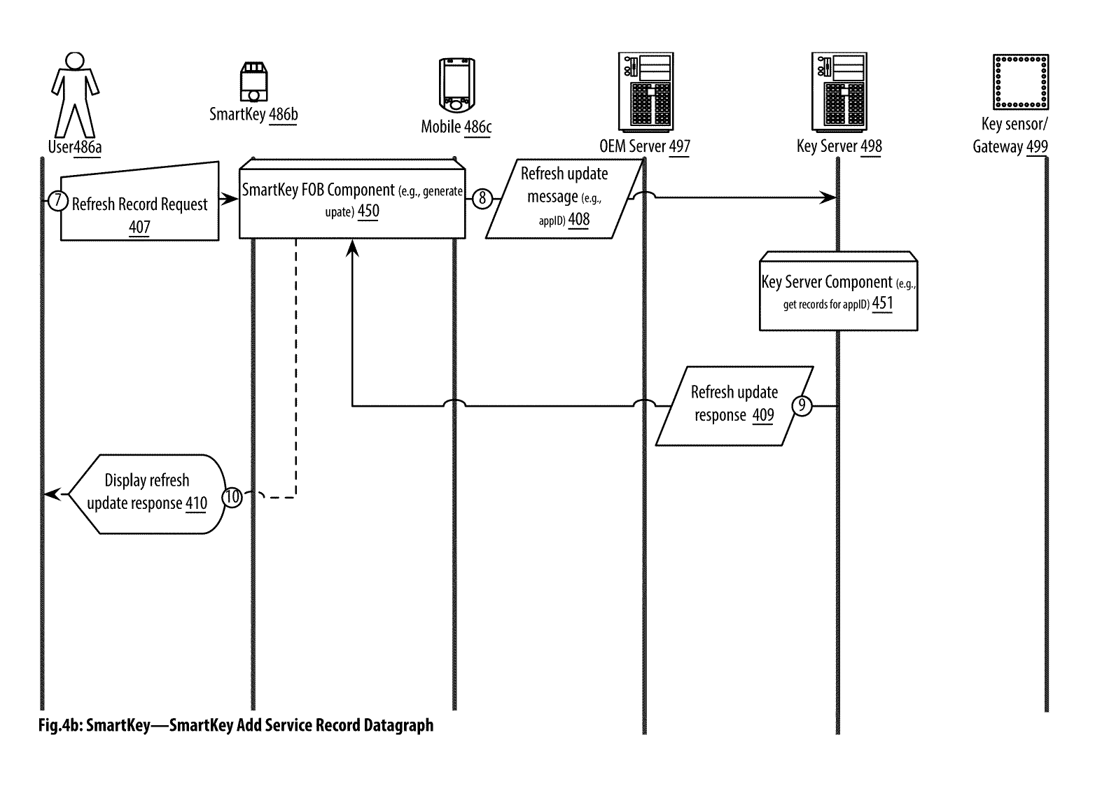

FIGS. 4a-4b shows a datagraph diagram illustrating embodiments of service record adding/updating for the SmartKey. A user 485 may perform some activities that will trigger an indication 401 to add records at the OEM 497 and Key Servers 498. For example, a connection to a mobile device with the SmartKey can trigger a synchronization activity. The SmartKey/Mobile device 486b/c SmartKey FOB Component 450 may obtain this trigger 401, and generate and record trigger message 402. An example add record trigger message 402, substantially in the form of a HTTP(S) POST message including XML-formatted data, is provided below:

```
POST /authrequest.php HTTP/1.1
Host: www.server.com
Content-Type: Application/XML
Content-Length: 667
<?XML version = “1.0” encoding = “UTF-8”?>
<AddRecordTriggerMessage>
    <timestamp>2020-12-31 23:59:59</timestamp>
    <user_accounts_details>
        <user_account_credentials>
            <user_name>JohnDaDoeDoeDoooe@gmail.com</
            account_name>
            <password>abc123</password>
            //OPTIONAL <cookie>cookieID</cookie>
            //OPTIONAL <digital_cert_link>
www.mydigitalcertificate.com/JohnDoeDaDoeDoe@gmail.com/
mycertifcate.dc</digital_cert_link>
            //OPTIONAL <digital_certificate>_DATA_</
            digital_certificate>
        </user_account_credentials>
    </user_accounts_details>
    <client_details> //Android Client with Webbrowser
        <client_IP>10.0.0.123</client_IP>
        <client_GPS>33.2, −96.7</client_GPS>
        <user_agent_string>Mozilla/5.0 (Linux; U; Android 4.0.4;
en-us; Nexus S Build/IMM76D) AppleWebKit/534.30 (KHTML, like
Gecko) Version/4.0 Mobile Safari/534.30</user_agent_string>
        <client_product_type>SmartKey</client_product_type>
        <client_product_OEM>GM</client_product_OEM>
        <client_product_OEM_model>Corvette</
        client_product_OEM_model>
        <client_OEM_serial_number>AXXXXXXXXC</
        client_OEM_serial_number>
        <client_serial_number>YXXXXXXXXZ</
        client_serial_number>
        <VIN>VINXXXXX1234</VIN>
        <client_UDID>FXXXXXXXXX-XXXX-XXXX-XXXX-
        XXXXXXXXXXXXX</client_UDID>
        <client_OS>Android</client_OS>
        <client_OS_version>4.0.4</client_OS_version>
        <client_app_type>web browser</client_app_type>
        <client_name>Mobile Safari</client_name>
        <client_version>534.30</client_version>
        <context>activate</context>
    <client_device_device_software_version_Stereo>1.0</
client_device_device_software_version_Stereo>
        <buttonContextDisplay>
            <1>Locate Car</1>
            <2>Honk horn, flash lights</2>
            <3>Panic</3>
            <4>(Un)lock Doors</4>
            <5>(Un)lock trunk</5>
        </buttonContextDisplay>
    </client_details>
    <messagePayload>
        <UserID>SmartKeySecureElementPublicKey</UserID>
        <appID>123ABC456XYZ</appID>
        <OEMID>PublicKeyOEMSecureElementKey</OEMID>
        <login_credentials_user>username</login_credentials_user>
        <login_credentials_password>password</
        login_credentials_password>
        <passcode>myPasscodeOrFingerprintCode</passcode>
        <usageLogsPayload>uselogs.txt.zip</usageLogsPayload>
        <activitySelectionPayload>4 unlock doors</
        activitySelectionPayload>
        <softwareUpdatePayload>file.zip</softwareUpdatePayload>
        //OPTIONAL <softwareUpdatePayload>URL_link</
        softwareUpdatePayload>
    </messagePayload>
</AddRecordTriggerMessage>
```

The OEM Server 497 obtains this message 402 and its OEM SmartKey Component 452 will obtain and decrypt the user's records with the passed on credentials. This may include history, usage, activities, software revisions regarding the user's use of the device associated with the Smartkey 452. In one embodiment, an information server (e.g., Apache) may run on the SmartKey, mobile device, vehicle, etc. and an open source analytics tracking module such as Open Web Analytics (OWA) may be installed to track usage of engaged pages, button presses therein, etc., and weblogs may be used to track analytics as well as via the OWA library features. In one embodiment, an open source software update framework such as (Win)Sparkle may be used to deliver software module payload updates. In one embodiment, for encryption and key management, an open source encryption framework Keyczar may be used. The OEM Server 497 may then generate and provide an add service request 404 to the Key Server 498, wherein, in one embodiment, the request 403 is similar to the add record message 402 (e.g., having a ‘ready to update’ flag, recordID, etc.). The Key Server Component 451 may then obtain the appID association for the OEMUserID and add an OEM record identifier and encrypt the information.

The KeyServer component may update its database of the OEM record identifier; An exemplary listing, written substantially in the form of PHP/SQL commands, to update the key record in the SmartKey database, is provided below:

<?PHP
header(‘Content-Type: text/plain’);
// store input data in a database
mysql_connect(″201.408.185.132″,$DBserver,$password); // access
database server
mysql_select(″SmartKey_DB.SQL″); // select database to append
mysql_query(“UPDATE OEMTable
SET userID = ‘username′, sessionID = ′XYZ123′, sessionToken =
‘sessionTokenData’, smartKeyID = ‘keyUniqueID’, passcode =
‘uniqueCode’, timestamp = ′2013-02-22 15:22:43′
WHERE userID = ′JDoe@gmail.com′, OEMID =
‘PublicKeyOEMSecureElementKey’ ″);
mysql_close(″SmartKey_DB.SQL″); // close connection to database
?>

The Key Server Component may then determine if items on the user's device need to be updated, and provide an add service response, which may include software updates itself and/or request for the OEM Server 497 to provide updates via refresh message 405, generated by the OEM SmartKey component 452, to the SmartKey FOB Component, which may itself be updated/refreshed and/or further updates on to the device associated/controlled by the SmartKey 486b. Status of refresh 406 may be provided to the user 486b. It should be noted that the refresh may be of credentials, and/or actual software components for the SmartKey FOB Component itself, and/or other components of the SmartKey 486b, helper devices 486c, and/or devices associated with the SmartKey (e.g., an automobile, etc.). Moving to FIG. 4b, the user may wish to refresh/update the record through some activity 407. Similarly to FIG. 4a, the SmartKey FOB Component may generate a refresh update message including the appID 408. For the Key Server's 498 Key Server Component 451. And similarly, the Key Server Component will get the records related to the appID and update, and generate a refresh update response message 409 and optionally provide update status to the user 410 as already discussed in FIG. 4a.

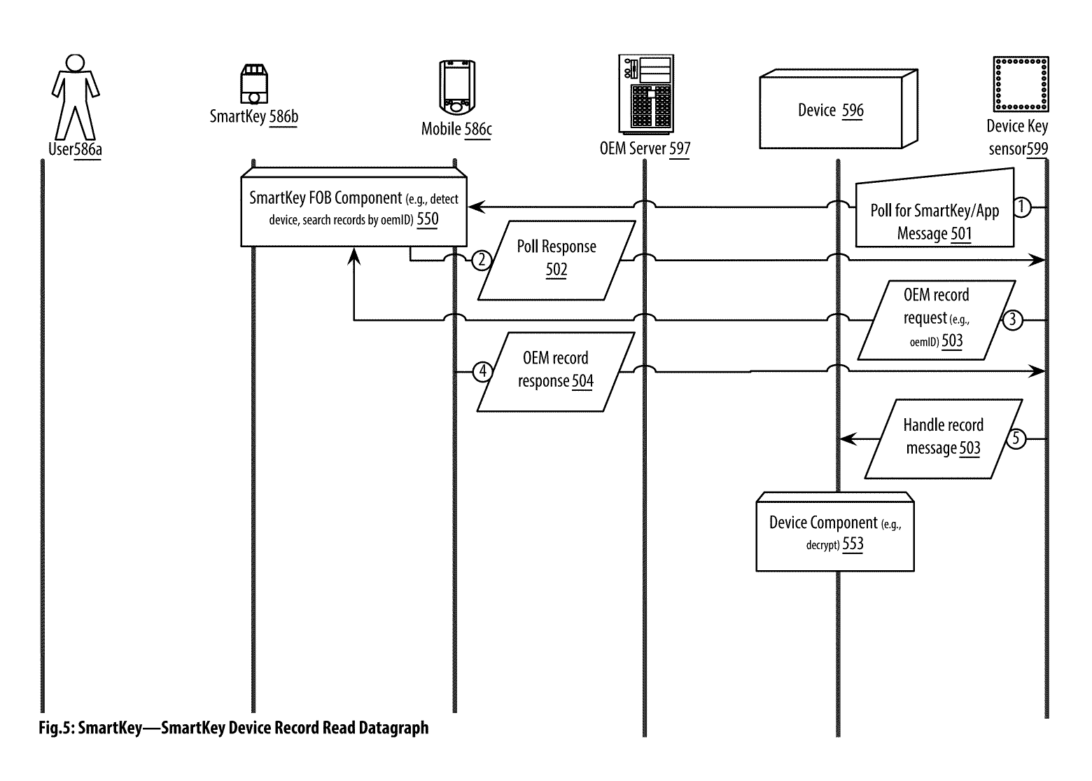

FIG. 5 shows a datagraph diagram illustrating embodiments of device record and read for the SmartKey. A device SmartKey sensor 599 (e.g., a proximity sensor for the SmartKey for door unlocking, etc.) may poll for SmartKey proximity and/or messages. In some embodiments, the device key sensor 599 may employ wireless communications (e.g., RF, Bluetooth, WiFi, near field technology, etc.) to determine devices in proximity, while in other embodiments, the device key sensor may be disposed in communication to a communications network and receive remote messages. In yet another embodiment, the device key sensor may poll for the SmartKey and/or app messages 501. The SmartKey 586b (and/or related devices 586c) may detect the message 501 and/or device sensor 599 and its SmartKey FOB component may then search records by OEMID 550. The Smartkey FOB Component 550 may then issue a poll response 502 for detection by the device key sensor 599. The device key sensor 599 may then cause the provision of an OEM record request (e.g., having an OEMID) 503 to the SmartKey FOB Component 550, which in turn, may issue an OEM record response 504 to the device key sensor 599. The device key sensor 599 may then generate a handle record message 503. The handle record message may include a number of activities specific to the device 596 associated with the SmartKey 586b (e.g., open door, software update, etc.). An example handle record message 503, substantially in the form of a HTTP(S) POST message including XML-formatted data, is provided below:

```
POST /authrequest.php HTTP/1.1
Host: www.server.com
Content-Type: Application/XML
Content-Length: 667
<?XML version = “1.0” encoding = “UTF-8”?>
<handleRecordMessage>
    <timestamp>2020-12-31 23:59:59</timestamp>
    <user_accounts_details>
        <user_account_credentials>
            <user_name>JohnDaDoeDoeDoooe@gmail.com</
            account_name>
            <password>abc123</password>
            //OPTIONAL <cookie>cookieID</cookie>
            //OPTIONAL <digital_cert_link>
www.mydigitalcertificate.com/JohnDoeDaDoeDoe@gmail.com/
mycertifcate.dc</digital_cert_link>
            //OPTIONAL <digital_certificate>_DATA_</
            digital_certificate>
        </user_account_credentials>
    </user_accounts_details>
    <client_details> //Android Client with Webbrowser
        <client_IP>10.0.0.123</client_IP>
        <client_GPS>33.2, −96.7</client_GPS>
        <user_agent_string>Mozilla/5.0 (Linux; U; Android 4.0.4;
en-us; Nexus S Build/IMM76D) AppleWebKit/534.30 (KHTML, like
Gecko) Version/4.0 Mobile Safari/534.30</user_agent_string>
        <client_product_type>SmartKey</client_product_type>
        <client_product_OEM>GM</client_product_OEM>
        <client_product_OEM_model>Corvette</
        client_product_OEM_model>
        <client_OEM_serial_number>AXXXXXXXXC</
        client_OEM_serial_number>
        <client_serial_number>YXXXXXXXXZ</
        client_serial_number>
        <VIN>VINXXXXX1234</VIN>
        <client_UDID>FXXXXXXXXX-XXXX-XXXX-XXXX-
        XXXXXXXXXXXXX</client_UDID>
        <client_OS>Android</client_OS>
        <client_OS_version>4.0.4</client_OS_version>
        <client_app_type>web browser</client_app_type>
        <client_name>Mobile Safari</client_name>
        <client_version>534.30</client_version>
        <context>activate</context>
    <client_device_device_software_version_Stereo>1.0</
client_device_device_software_version_Stereo>
        <buttonContextDisplay>
            <1>Locate Car</1>
            <2>Honk horn, flash lights</2>
            <3>Panic</3>
            <4>(Un)lock Doors</4>
            <5>(Un)lock trunk</5>
        </buttonContextDisplay>
    </client_details>
    <messagePayload>
        <UserID>SmartKeySecureElementPublicKey</UserID>
        <appID>123ABC456XYZ</appID>
        <OEMID>PublicKeyOEMSecureElementKey</OEMID>
        <login_credentials_user>username</login_credentials_user>
        <login_credentials_password>password</
        login_credentials_password>
        <passcode>myPasscodeOrFingerprintCode</passcode>
        <activity>unlockDoor</activity>
        <activity2>updateStereoSoftware</activity2>
    <activity2DataPackage>softwareUpdateDataPayload</
    activity2DataPackage>
    </messagePayload>
</handleRecordMessage>
```

An alternative example of handle record message 503 may look as follows:

```
<?xml version=‘1.0’ encoding=‘UTF-8’?>
<keyrecord xsi:noNamespaceSchemaLocation=“/Users/msearle/
Desktop/keyrecord.xsd” originalname=“VALUE”
fullname=“VALUE”
xmlns:xsi=“http://www.w3.org/2001/XMLSchema-instance”>
    <capabilitylist>
        <capability name=radiopresets>
            <capname>playlist<capname>
            <capvalue>radio4,radio3,radio2</capvalue>
        </capability>
        <capability name=navigationPOI>
            <capname>Acme Corporate Headquarters<capname>
            <capvalue>123 Main Street, Mountain View,
            CA 94043, USA </capvalue>
        </capability>
        <capability name=Seat position>
            <capname>Driverseat<capname>
            <capvalue>55%</capvalue>
        </capability>
    </capabilitylist>
</keyrecord>
```

The device component 553 may obtain the message 503, decrypt it and apply the activity.

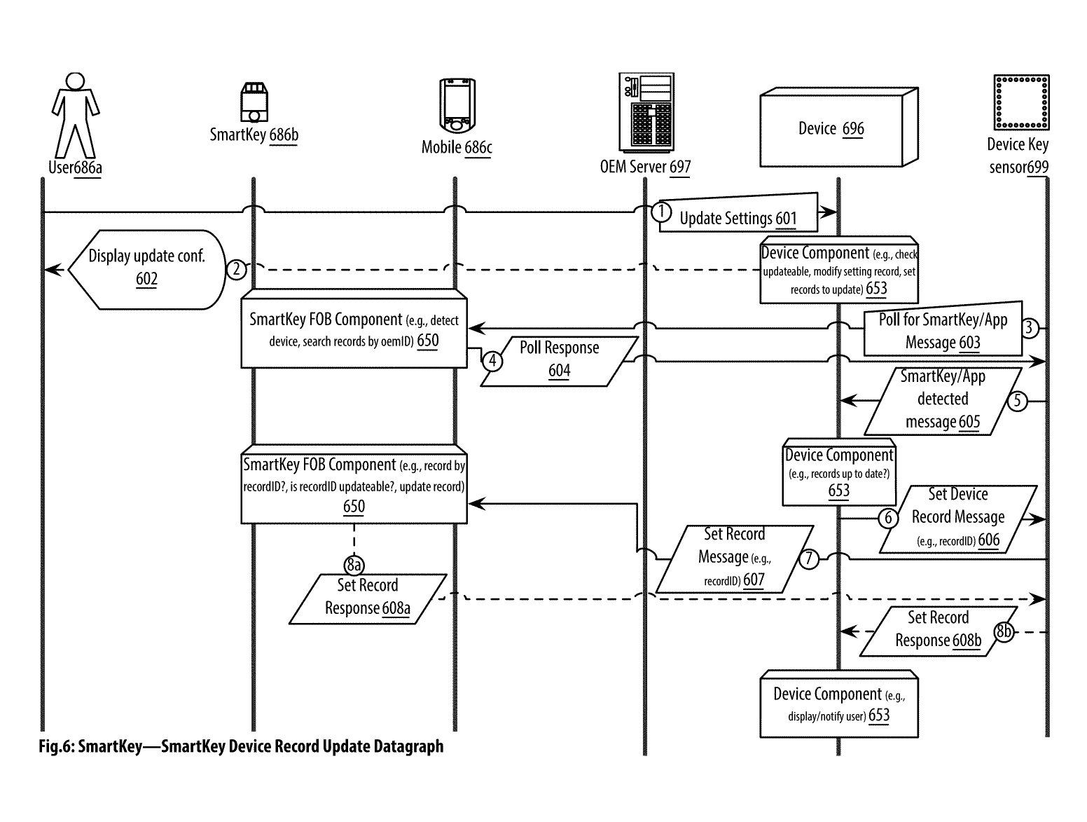

FIG. 6 shows a datagraph diagram illustrating embodiments of device record and update for the SmartKey. A user may regularly update settings 601 on a device 696 associated with the SmartKey 686b. The device's 696 device (e.g., car, appliance, computer, home (e.g., home automation system and/or locks, etc.), etc.) component 653 may check to see if the settings are updateable, modify the settings record, set the records and flags to update and provide confirmation (e.g., via display, message notification, etc.) 602 to the user 686a). All the while, as has largely been discussed in FIG. 5, the device's key sensor 699 may poll for the SmartKey 603, which may be detected by the SmartKey and its SmartKey FOB Component 650, and which in turn may provide a poll response 604. Once the device key sensor 699 obtains the poll response 604, and it provides notification message of the detected SmartKey 605 to the device 696, the device's component 653 may then determine if the updated settings are up to date and issue a set device record message with the proper recordID 606 to the device key sensor 699, which in turn may relay the set record message 607 to the SmartKey FOB Component 650. The SmartKey FOB Component 650 may then record the updated information associated with the recordID if it determines the setting is updatable. Optionally, the SmartKey FOB Component 650 may provide a set record response 608a to the device key sensor 699, which in turn may provide it back to the device for display/notification to the user via the device component 653.

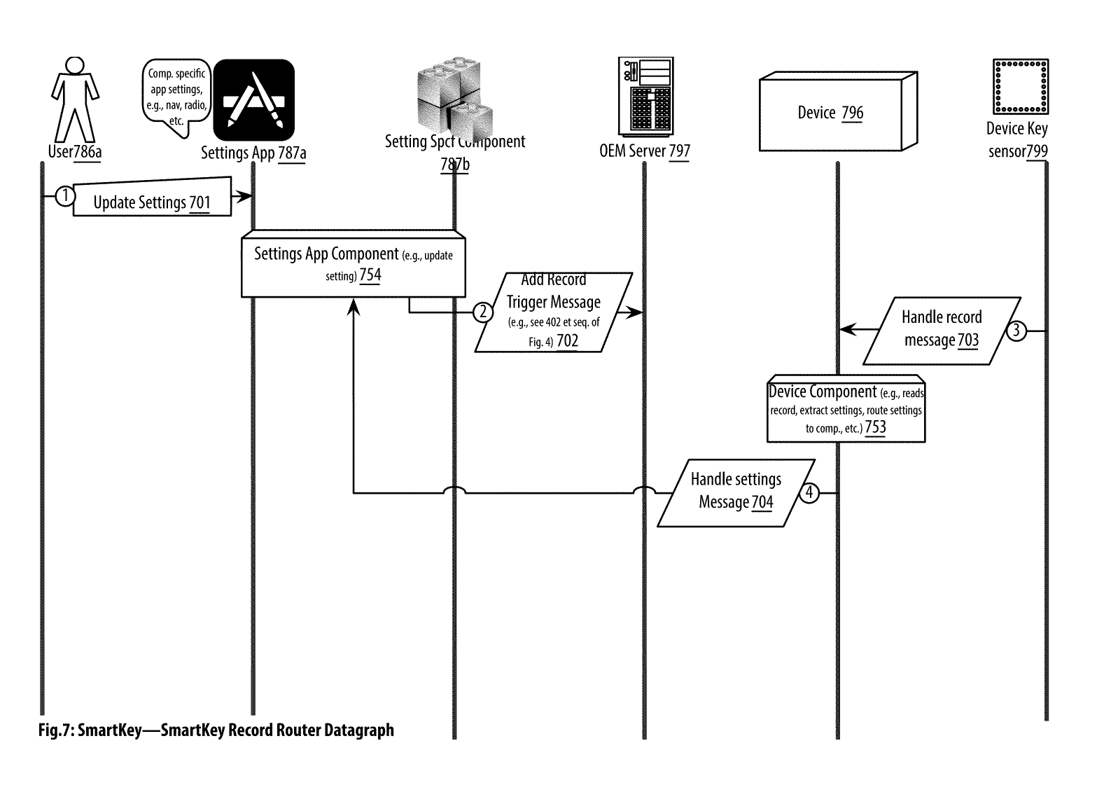

FIG. 7 shows a datagraph diagram illustrating embodiments of a record router for the SmartKey. Here the user 786a may engage in updating settings in a settings application 787. These settings could be component specific application settings such navigation way points and preferences, radio stations, sound volume levels and balances, etc. Such an embodiment allows for other devices (e.g., mobile devices, smart phones, tablets, desktop computers (e.g., via dedicated applications and/or web access), etc.). As such, the settings application 787a and/or setting specific component 787b may have its settings app component register settings updates 754 and generate add record trigger message (e.g., see 402 et seq. of FIG. 4) 702 to the OEM server 797. Also, the device key sensor 799 when sending a handle record message 703 to the device 796 may have its device component 753 read, record, extract settings, route settings, and provide those to the settings app component 754 via handle settings message 704. As such, the settings app component can be a conduit for setting and obtaining the latest information about a given device, and/or set of devices and by providing information to the OEM server 797, eventually, updates to setting may reach the device associated with the SmartKey as described in earlier figures.

### SmartKey Controller

FIG. 8 shows a block diagram illustrating embodiments of a SmartKey controller. In this embodiment, the SmartKey controller 801 may serve to aggregate, process, store, search, serve, identify, instruct, generate, match, and/or facilitate interactions with a computer through locking devices technologies, and/or other related data.

Typically, users, which may be people and/or other systems, may engage information technology systems (e.g., computers) to facilitate information processing. In turn, computers employ processors to process information; such processors 803 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 829 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SmartKey controller 801 may be connected to and/or communicate with entities such as, but not limited to: one or more users from peripheral devices 812 (e.g., user input devices 811); an optional cryptographic processor device 828; and/or a communications network 813.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The SmartKey controller 801 may be based on computer systems that may comprise, but are not limited to, components such as: a computer systemization 802 connected to memory 829.

### Computer Systemization

A computer systemization 802 may comprise a dock 830, central processing unit (“CPU(s)” and/or “processor(s)” (these terms are used interchangeable throughout the disclosure unless noted to the contrary)) 803, a memory 829 (e.g., a read only memory (ROM) 806, a random access memory (RAM) 805, etc.), and/or an interface bus 807, and most frequently, although not necessarily, are all interconnected and/or communicating through a system bus 804 on one or more (mother)board(s) 802 having conductive and/or otherwise transportive circuit pathways through which instructions (e.g., binary encoded signals) may travel to effectuate communications, operations, storage, etc. The computer systemization may be connected to a power source 886; e.g., optionally the power source may be internal. Optionally, a cryptographic processor and/or secure element 826 may be connected to the system bus. The secure element may house and maintain information securely, e.g., biometric information such as a fingerprint, so that the information may be verified without allowing access to the information beyond the secure element. In another embodiment, the cryptographic processor, transceivers (e.g., ICs) 874, and/or sensor array (e.g., accelerometer, altimeter, ambient light, barometer, global positioning system (GPS) (thereby allowing SmartKey controller to determine its location), gyroscope, magnetometer, pedometer, proximity, ultra-violet sensor, etc.) 573 may be connected as either internal and/or external peripheral devices 812 via the interface bus I/O 808 (not pictured) and/or directly via the interface bus 807. In turn, the transceivers may be connected to antenna(s) 875, thereby effectuating wireless transmission and reception of various communication and/or sensor protocols; for example the antenna(s) may connect to various transceiver chipsets (depending on deployment needs), including. Broadcom BCM4329FKUBG transceiver chip (e.g., providing 802.11n, Bluetooth 2.1+EDR, FM, etc.); a Broadcom BCM4752 GPS receiver with accelerometer, altimeter, GPS, gyroscope, magnetometer; a Broadcom BCM4335 transceiver chip (e.g., providing 2G, 3G, and 4G long-term evolution (LTE) cellular communications; 802.11ac, Bluetooth 4.0 low energy (LE) (e.g., beacon features)); a Broadcom BCM43341 transceiver chip (e.g., providing 2G, 3G and 4G LTE cellular communications; 802.11g/, Bluetooth 4.0, near field communication (NFC), FM radio); an Infineon Technologies X-Gold 618-PMB9800 transceiver chip (e.g., providing 2G/3G HSDPA/HSUPA communications); a MediaTek MT6620 transceiver chip (e.g., providing 802.11a/b/g/n, Bluetooth 4.0 LE, FM, GPS; a Lapis Semiconductor ML8511 UV sensor; a maxim integreated MAX44000 ambient light and infrared proximity sensor; a Texas Instruments WiLink WL1283 transceiver chip (e.g., providing 802.11n, Bluetooth 3.0, FM, GPS); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The dock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large mainframe computers, down to mini computers, servers, desktop computers, laptops, netbooks, tablets (e.g., iPads, Android and Windows tablets, etc.), mobile smartphones (e.g., iPhones, Android and Windows phones, etc.), wearable devise (e.g., watches, glasses, goggles (e.g., Google Glass), etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 829 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; Apple's A series of processors (e.g., A5, A6, A7, etc.); ARM's application, embedded and secure processors; IBM and/or Motorola's DragonBall and PowerPC; IBM's and Sony's Cell processor; Intel's 80X86 series (e.g., 80386, 80486), Pentium, Celeron, Core (2) Duo, i series (e.g., i3, i5, i7, etc.), Itanium, Xeon, and/or XScale; Motorola's 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the SmartKey controller and beyond through various interfaces. Should processing requirements dictate a greater amount speed and/or capacity, distributed processors (e.g., Distributed SmartKey), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the SmartKey may be achieved by implementing a microcontroller such as CAST's R8051XC2 microcontroller; Intel's MCS 51 (i.e., 8051 microcontroller); and/or the like. Also, to implement certain features of the SmartKey, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SmartKey component collection (distributed or otherwise) and/or features may be implemented via the microprocessor and/or via embedded components; e.g., via ASIC, coprocessor, DSP, FPGA, and/or the like. Alternately, some implementations of the SmartKey may be implemented with embedded components that are configured and used to achieve a variety of features or signal processing.

Depending on the particular implementation, the embedded components may include software solutions, hardware solutions, and/or some combination of both hardware/software solutions. For example, SmartKey features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the SmartKey features. A hierarchy of programmable interconnects allow logic blocks to be interconnected as needed by the SmartKey system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the SmartKey may be developed on regular FPGAs and then migrated into a fixed version that more resembles ASIC implementations. Alternate or coordinating implementations may migrate SmartKey controller features to a final ASIC instead of or in addition to FPGAs. Depending on the implementation all of the aforementioned embedded components and microprocessors may be considered the “CPU” and/or “processor” for the SmartKey.

### Power Source

The power source 886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 886 is connected to at least one of the interconnected subsequent components of the SmartKey thereby providing an electric current to all subsequent components. In one example, the power source 886 is connected to the system bus component 804. In an alternative embodiment, an outside power source 886 is provided through a connection across the I/O 808 interface. For example, a USB and/or IEEE 1394 connection carries both data and power across the connection and is therefore a suitable source of power.

### Interface Adapters

Interface bus(ses) 807 may accept, connect, and/or communicate to a number of interface adapters, conventionally although not necessarily in the form of adapter cards, such as but not limited to: input output interfaces (I/O) 808, storage interfaces 809, network interfaces 810, and/or the like. Optionally, cryptographic processor interfaces 827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 809 may accept, communicate, and/or connect to a number of storage devices such as, but not limited to: storage devices 814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 810 may accept, communicate, and/or connect to a communications network 813. Through a communications network 813, the SmartKey controller is accessible through remote clients 833b (e.g., computers with web browsers) by users 833a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., Distributed SmartKey), architectures may similarly be employed to pool, load balance, and/or otherwise decrease/increase the communicative bandwidth required by the SmartKey controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 810 may be used to engage with various communications network types 813. For example, multiple network interfaces may be employed to allow for the communication over broadcast, multicast, and/or unicast networks.

Input Output interfaces (I/O) 808 may accept, communicate, and/or connect to user, peripheral devices 812 (e.g., input devices 811), cryptographic processor devices 828, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

Peripheral devices 812 may be connected and/or communicate to I/O and/or other facilities of the like such as network interfaces, storage interfaces, directly to the interface bus, system bus, the CPU, and/or the like. Peripheral devices may be external, internal and/or part of the SmartKey controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 811 often are a type of peripheral device 512 (see above) and may include: card readers, dongles, finger print readers, gloves, graphics tablets, joysticks, keyboards, microphones, mouse (mice), remote controls, security/biometric devices (e.g., fingerprint reader, iris reader, retina reader, etc.), touch screens (e.g., capacitive, resistive, etc.), trackballs, trackpads, styluses, and/or the like.

It should be noted that although user input devices and peripheral devices may be employed, the SmartKey controller may be embodied as an embedded, dedicated, and/or monitor-less (i.e., headless) device, wherein access would be provided over a network interface connection.

Cryptographic units such as, but not limited to, microcontrollers, processors 826, interfaces 827, and/or devices 828 may be attached, and/or communicate with the SmartKey controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 829. However, memory is a fungible technology and resource, thus, any number of memory embodiments may be employed in lieu of or in concert with one another. It is to be understood that the SmartKey controller and/or a computer systemization may employ various forms of memory 829. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 829 will include ROM 806, RAM 805, and a storage device 814. A storage device 814 may be any conventional computer system storage. Storage devices may include: an array of devices (e.g., Redundant Array of Independent Disks (RAID)); a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; solid state memory devices (USB memory, solid state drives (SSD), etc.); other processor-readable storage mediums; and/or other devices of the like. Thus, a computer systemization generally requires and makes use of memory.

### Component Collection

The memory 829 may contain a collection of program and/or database components and/or data such as, but not limited to: operating system component(s) 815 (operating system); information server component(s) 816 (information server); user interface component(s) 817 (user interface); Web browser component(s) 818 (Web browser); database(s) 819; mail server component(s) 821; mail client component(s) 822; cryptographic server component(s) 820 (cryptographic server); the SmartKey component(s) 835; and/or the like (i.e., collectively a component collection). These components may be stored and accessed from the storage devices and/or from storage devices accessible through an interface bus. Although non-conventional program components such as those in the component collection, typically, are stored in a local storage device 814, they may also be loaded and/or stored in memory such as: peripheral devices, RAM, remote storage facilities through a communications network, ROM, various forms of memory, and/or the like.

### Operating System

The operating system component 815 is an executable program component facilitating the operation of the SmartKey controller. Typically, the operating system facilitates access of I/O, network interfaces, peripheral devices, storage devices, and/or the like. The operating system may be a highly fault tolerant, scalable, and secure system such as: Apple's Macintosh OS X (Server); AT&T Plan 9; Be OS; Google's Chrome; Microsoft's Windows 7/8; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/Mobile/NT/Vista/XP (Server), Palm OS, and/or the like. Additionally, for robust mobile deployment applications, mobile operating systems may be used, such as: Apple's iOS; China Operating System COS; Google's Android; Microsoft Windows RT/Phone; Palm's WebOS; Samsung/Intel's Tizen; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the SmartKey controller to communicate with other entities through a communications network 813. Various communication protocols may be used by the SmartKey controller as a subcarrier transport mechanism for interaction, such as, but not limited to: multicast, TCP/IP, UDP, unicast, and/or the like.

### Information Server

An information server component 816 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SmartKey controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SmartKey database 819, operating systems, other program components, user interfaces, Web browsers, and/or the like.

Access to the SmartKey database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SmartKey. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the SmartKey as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple's iOS, Macintosh Operating System's Aqua; IBM's OS/2; Google's Chrome; Microsoft's Windows varied UIs 2000/2003/3.1/95/98/CE/Millenium/Mobile/NT/Vista/XP (Server) (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 817 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 818 is a stored program component that is executed by a CPU. The Web browser may be a conventional hypertext viewing application such as Apple's (mobile) Safari, Google's Chrome, Microsoft Internet Explorer, Mozilla's Firefox, Netscape Navigator, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the SmartKey enabled nodes. The combined application may be nugatory on systems employing standard Web browsers.

### Mail Server

A mail server component 821 is a stored program component that is executed by a CPU 803. The mail server may be a conventional Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the SmartKey.

Access to the SmartKey mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 822 is a stored program component that is executed by a CPU 803. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 820 is a stored program component that is executed by a CPU 803, cryptographic processor 826, cryptographic processor interface 827, cryptographic processor device 828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the SmartKey may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the SmartKey component to engage in secure transactions if so desired. The cryptographic component facilitates the secure accessing of resources on the SmartKey and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The SmartKey Database

The SmartKey database component 819 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SmartKey database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the SmartKey database is implemented as a data-structure, the use of the SmartKey database 819 may be integrated into another component such as the SmartKey component 835. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 819 includes several tables 819a-h:

An accounts table 819a includes fields such as, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountNumber, routingNumber, linkWalletsID, accountPrioritAccaountRatio, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;

A users table 819b includes fields such as, but not limited to: a userID, userSSN, taxID, userContactID, accountID, assetIDs, deviceIDs, paymentIDs, transactionIDs, keyID, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a SmartKey);

An devices table 819c includes fields such as, but not limited to: deviceID, accountID, assetIDs, paymentIDs, actionIDs, OEMIDs, keyIDs, deviceType, deviceName, deviceModel, deviceVersion, deviceSerialNo, VIN, deviceIPaddress, deviceMACaddress, device_ECID, deviceUUID, deviceLocation, deviceCertificate, deviceOS, appIDs, deviceResources, deviceSession, authKey, deviceSecureKey, walletAppInstalledFlag, deviceAccessPrivileges, device Preferences, deviceRestrictions, and/or the like;

An apps table 819d includes fields such as, but not limited to: appID, appName, appType, appDependencies, accountID, deviceIDs, ActionIDs, OEMIDs, KeyIDs, transactionID, userID, appStoreAuthKey, appStoreAccountID, appStoreIPaddress, appStoreURLaccessCode, appStorePortNo, appAccessPrivileges, appPreferences, appRestrictions, portNum, access_API_call, linked_wallets_list, and/or the like;

An assets table 819e includes fields such as, but not limited to: assetID, accountID, userID, distributorAccountID, distributorPaymentID, distributorOnwerID, actionIDs, OEMIDs, keyIDs, deviceID, assetType, assetName, assetCode, assetQuantity, assetCost, assetPrice, assetManufactuer, assetModelNo, assetSerialNo, assetLocation, assetAddress, assetState, assetZIPcode, assetState, assetCountry, assetEmail, assetIPaddress, assetURLaccessCode, assetOwnerAccountID, subscriptionIDs, assetAuthroizationCode, assetAccessPrivileges, assetPreferences, assetRestrictions, and/or the like;

A payments table 819f includes fields such as, but not limited to: paymentID, accountID, userID, actionIDs, OEMIDs, keyIDs, deviceID, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentIPaddress, paymentURLaccessCode, paymentPortNo, paymentAccessPrivileges, paymentPreferences, payementRestrictions, and/or the like;

An transactions table 819g includes fields such as, but not limited to: transactionID, accountID, assetIDs, deviceIDs, paymentIDs, transactionIDs, userID, merchantID, transactionType, transactionDate, transactionTime, transactionAmount, transactionQuantity, transactionDetails, productsList, productType, productTitle, productsSummary, productParamsList, transactionNo, transactionAccessPrivileges, transactionPreferences, transactionRestrictions, merchantAuthKey, merchantAuthCode, and/or the like;

An merchants table 819h includes fields such as, but not limited to: merchantID, merchantTaxID, merchanteName, merchantContactUserID, accountID, issuerID, acquirerID, merchantEmail, merchantAddress, merchantState, merchantZIPcode, merchantCountry, merchantAuthKey, merchantIPaddress, portNum, merchantURLaccessCode, merchantPortNo, merchantAccessPrivileges, merchantPreferences, merchantRestrictions, and/or the like;

A OEM table 819h includes fields such as, but not limited to: OEMID, OEM_name, OEM_address, OEM_contact, assetID, appID, keyID, actionID, transactionID, OEM_publicKeySecureElement, smartKeyServerID, userID, OEM_userID, deviceID, and/or the like.

A Key table 819i includes fields such as, but not limited to: keyID, smartKeyID, smartKeyModelNo, smartKeySerialNo, OEM_publicKeySecureElement, smartKeyServerID, user_publicKeySecureElement, user_privateKeySecureElement, username, credentials, passcode, session, sessionID, sessionTokenData, assetID, appID, actionID, transactionID, userID, OEMID, deviceID, and/or the like.

A Activity table 819j includes fields such as, but not limited to: ActivityID, ActivityMethodName, ActivityDeviceMapNames, assetID, appID, keyID, actionID, transactionID, OEMID, userID, KeyID, deviceID, and/or the like.

In one embodiment, the SmartKey database may interact with other database systems. For example, employing a distributed database system, queries and data access by search SmartKey component may treat the combination of the SmartKey database, an integrated data security layer database as a single database entity.

In one embodiment, user programs may contain various user interface primitives, which may serve to update the SmartKey. Also, various accounts may require custom database tables depending upon the environments and the types of clients the SmartKey may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 819a-h. The SmartKey may be configured to keep track of various settings, inputs, and parameters via database controllers.

The SmartKey database may communicate to and/or with other components in a component collection, including itself, and/or facilities of the like. Most frequently, the SmartKey database communicates with the SmartKey component, other program components, and/or the like. The database may contain, retain, and provide information regarding other nodes and data.

### The SmartKeys

The SmartKey component 835 is a stored program component that is executed by a CPU. In one embodiment, the SmartKey component incorporates any and/or all combinations of the aspects of the SmartKey that was discussed in the previous figures. As such, the SmartKey affects accessing, obtaining and the provision of information, services, transactions, and/or the like across various communications networks. The features and embodiments of the SmartKey discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the SmartKey's features and facilities, and in many cases reduce the costs, energy consumption/requirements, and extend the life of SmartKey's underlying infrastructure; this has the added benefit of making the SmartKey more reliable. Similarly, many of the features and mechanisms are designed to be easier for users to use and access, thereby broadening the audience that may enjoy/employ and exploit the feature sets of the SmartKey; such ease of use also helps to increase the reliability of the SmartKey. In addition, the feature sets include heightened security as noted via the Cryptographic components 820, 826, 828 and throughout, making access to the features and data more reliable and secure

The SmartKey transforms start SmartKey app, login authentication, pair OEM, passcode, add record trigger, refresh record request, poll for SmartKey, update settings request, etc. inputs, via SmartKey components (e.g., SmartKey FOB 850, Key Server 851, OEM Key Server 852, Device 853, Settings App 854, etc.), into handle record, save device settings update, register SmartKey with OEM, register SmartKey with key server, etc. outputs.

The SmartKey component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the SmartKey server employs a cryptographic server to encrypt and decrypt communications. The SmartKey component may communicate to and/or with other components in a component collection, including itself, and/or facilities of the like. Most frequently, the SmartKey component communicates with the SmartKey database, operating systems, other program components, and/or the like. The SmartKey may contain, communicate, generate, obtain, and/or provide program component, system, user, and/or data communications, requests, and/or responses.

### Distributed SmartKeys

The structure and/or operation of any of the SmartKey node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the SmartKey controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (SON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the SmartKey controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
    $input = “”;
    $input = socket_read($client, 1024);
    $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=
/com.ibm.IBMDI.doc/referenceguide295.htm

and other parser implementations:

http://publib.boulder.ibm.com/infocenter/tivihelp/v2r1/index.jsp?topic=
/com.ibm.IBMDI.doc/referenceguide259.htm

all of which are hereby expressly incorporated by reference.

Additional SmartKey embodiments include:
1. A smart key apparatus, comprising:
   a smart key housing containing
   a memory;
   a component collection in the memory, including:
      an application identifier (ID) component,
      user ID component,
      an original equipment manufacturer (OEM) ID component,
      a device ID, wherein the device ID is a device associated with the smart key,
      a smart key secure element component having a unique value, wherein the secure element may be used to generate any of: encryption keys, encrypted data, secure tokens, and passcodes;
      a smart key fob component, wherein the smart key fob may subsume previous components;
   a processor disposed in communication with the memory, and configured to issue a plurality of processing instructions from the component collection stored in the memory,
      wherein the processor issues instructions from the smart key fob component, stored in the memory, to:
         register a user ID component with a key server;
         register a application ID component with a key server;
         generate a passcode for action at a device referenced by the device ID;
         provide an action to the device referenced by the device ID;
   a touch screen disposed in communication with the processor for display of smart key interaction with devices associated by device ID;
   a sensor array disposed in communication with the processor;
   at least one programmable context aware engageable input indicator disposed in communication with the processor;
   a connector disposed in communication with the processor and configured to communicate with outside devices, and
   a transceiver disposed in communication with the processor.
2. The apparatus of embodiment 1, wherein the action may be any of a device action, a device setting update, a software update.
3. The apparatus of embodiment 1, wherein the key server is an OEM key server.
4. The apparatus of embodiment 1, wherein a device associated by device ID is a vehicle.
5. The apparatus of embodiment 4, wherein said smart key apparatus is further configured to pass usage information from said vehicle via a mobile phone to a smart key server for data analysis.
6. The apparatus of embodiment 4, wherein said smart key apparatus is further configured to pass usage information to said vehicle via a mobile phone to a smart key server.
7. The apparatus of embodiment 4, wherein said smart key apparatus is further configured to pass a software update to said vehicle via a mobile phone from a smart key server.
8. The apparatus of embodiment 4, wherein a second device associated by device IP is a second vehicle.
9. The apparatus of embodiment 8, wherein said smart key apparatus serves as a conduit to transfer settings used for a first vehicle to a second vehicle.
10. The apparatus of embodiment 1 wherein a passcode used within said smart key secure element component is an alphanumeric value.
11. The apparatus of embodiment 1 wherein a passcode used within said smart key secure element component is an audible code.
12. The apparatus of embodiment 1 wherein a passcode used within said smart key secure element component is a biometric.
13. The apparatus of embodiment 12 wherein a passcode used within said biometric is a fingerprint.
14. The apparatus of embodiment 1 wherein a passcode used within said smart key secure element component is encrypted.
15. The apparatus of embodiment 1 wherein the deviceID is registered with an OEM.
16. The apparatus of embodiment 15 further configured to receive method mapping from said OEM for device activities to the smart key fob component.
17. The apparatus of embodiment 16 wherein said method mapping comprises instructions for an opentrunk function by OEM maps to open a vehicle trunk upon activation of a button on the keyfob.
18. A processor-readable smart key non-transient medium storing processor-executable components, the components, comprising:
   a component collection stored in the medium, including
   an application identifier (ID) component,
      user ID component,
      an original equipment manufacturer (OEM) ID component,
      a device ID, wherein the device ID is a device associated with the smart key,
      a smart key secure element component having a unique value, wherein the secure element may be used to generate any of: encryption keys, encrypted data, secure tokens, and passcodes;
      a smart key fob component, wherein the smart key fob may subsume previous components;
      wherein said smart key fob component collection provides instructions to a processor to:
         register a user ID component with a key server;
         register a application ID component with a key server;
         generate a passcode for action at a device referenced by the device ID;
         provide an action to the device referenced by the device ID; and
      wherein said smart key fob component provides instructions to a touch screen disposed in communication with the processor for display of smart key interaction with devices associated by device ID.
19. The medium of embodiment 18, wherein the action may be any of a device action, a device setting update, a software update.
20. The medium of embodiment 18, wherein the key server is an OEM key server.
21. The medium of embodiment 18, wherein a device associated by device ID is a vehicle.
22. The medium of embodiment 21, wherein said smart key apparatus is further configured to pass usage information from said vehicle via a mobile phone to a smart key server for data analysis.
23. The medium of embodiment 21, wherein said smart key apparatus is further configured to pass usage information to said vehicle via a mobile phone to a smart key server.
24. The medium of embodiment 21, wherein said smart key apparatus is further configured to pass a software update to said vehicle via a mobile phone from a smart key server.
25. The medium of embodiment 21, wherein a second device associated by device IP is a second vehicle.
26. The medium of embodiment 21, wherein said smart key apparatus serves as a conduit to transfer settings used for a first vehicle to a second vehicle.
27. The medium of embodiment 18 wherein a passcode used within said smart key secure element component is an alphanumeric value.
28. The medium of embodiment 18 wherein a passcode used within said smart key secure element component is an audible code.
29. The medium of embodiment 18 wherein a passcode used within said smart key secure element component is a biometric.
30. The medium of embodiment 29 wherein a passcode used within said biometric is a fingerprint.
31. The medium of embodiment 18 wherein a passcode used within said smart key secure element component is encrypted.
32. The medium of embodiment 18 wherein the deviceID is registered with an OEM.
33. The medium of embodiment 32 wherein said component collection is further configured to receive method mapping from said OEM for device activities to the smart key fob component.
34. The medium of embodiment 33 wherein said method mapping comprises instructions for an opentrunk function by OEM maps to open a vehicle trunk upon activation of a button on the keyfob.
35. A processor-implemented smart key system, comprising:
   a smart key means for housing:
   a memory;
   a component collection in the memory, including:
      an application identifier (ID) component,
      user ID component,
      an original equipment manufacturer (OEM) ID component,
      a device ID, wherein the device ID is a device associated with the smart key,
      a smart key secure element component having a unique value, wherein the secure element may be used to generate any of: encryption keys, encrypted data, secure tokens, and passcodes;
      a smart key fob component, wherein the smart key fob may subsume previous components;
   a processor means disposed in communication with the memory for issuing a plurality of processing instructions from the component collection stored in the memory,
      wherein the processor means issues instructions from the smart key fob component, stored in the memory, to:
         register a user ID component with a key server;
         register a application ID component with a key server;
         generate a passcode for action at a device referenced by the device ID;
         provide an action to the device referenced by the device ID;
   a touch screen means disposed in communication with the processor for displaying smart key interaction with devices associated by device ID;
   a sensor array means disposed in communication with the processor;
   at least one programmable context aware engageable input indicator means disposed in communication with the processor;
   a connector means disposed in communication with the processor and configured for communicating with outside devices, and
   a transceiver means disposed in communication with the processor.
36. The smart key system of embodiment 35 wherein the action may be any of a device action, a device setting update, and a software update.
37. The smart key system of embodiment 35, wherein the key server is an OEM key server.
38. The smart key system of embodiment 35, wherein a device associated by device ID is a vehicle.
39. The smart key system of embodiment 38, wherein said smart key system is further configured to pass usage information from said vehicle via a mobile phone to a smart key server for data analysis.
40. The smart key system of embodiment 39, wherein said smart key system is further configured to pass usage information to said vehicle via a mobile phone to a smart key server.
41. The smart key system of embodiment 39, wherein said smart key system is further configured to pass a software update to said vehicle via a mobile phone from a smart key server.
42. The smart key system of embodiment 38, wherein a second device associated by device IP is a second vehicle.
43. The smart key system of embodiment 42, wherein said smart key system serves as a conduit to transfer settings used for a first vehicle to a second vehicle.
44. The smart key system of embodiment 38 wherein a passcode used within said smart key secure element component is an alphanumeric value.
45. The smart key system of embodiment 38 wherein a passcode used within said smart key secure element component is an audible code.
46. The smart key system of embodiment 38 wherein a passcode used within said smart key secure element component is a biometric.
47. The smart key system of embodiment 46 wherein a passcode used within said biometric is a fingerprint.
48. The smart key system of embodiment 38 wherein a passcode used within said smart key secure element component is encrypted.
49. The smart key system of embodiment 38 wherein the deviceID is registered with an OEM.
50. The smart key system of embodiment 49 further configured to receive method mapping from said OEM for device activities to the smart key fob component.
51. The smart key system of embodiment 50 wherein said method mapping comprises instructions for an opentrunk function by OEM maps to open a vehicle trunk upon activation of a button on the keyfob.
52. A method for using a smart key for device analytics and control, comprising:
   registering a user ID component of a smart key with a key server;
   registering an application ID component of a smart key with a key server;
   generating a passcode for action at a device referenced by a device ID;
   providing an action to the device referenced by the device ID;
      wherein said smart key contains:
   a memory;
   a component collection in the memory, including:
      an application identifier (ID) component,
      user ID component,
      an original equipment manufacturer (OEM) ID component,
      a device ID, wherein the device ID is a device associated with the smart key,
      a smart key secure element component having a unique value, wherein the secure element may be used to generate any of: encryption keys, encrypted data, secure tokens, and passcodes;
      a smart key fob component, wherein the smart key fob may subsume previous components;
   and further wherein:
   a touch screen is disposed in communication with the smart key for display of smart key interaction with devices associated by device ID;
   a sensor array is disposed in communication with the smart key;
   at least one programmable context aware engageable input indicator is disposed in communication with the processor;
   a connector is disposed in communication with the processor and configured to communicate with outside devices, and
   a transceiver is disposed in communication with the processor.
53. The method of embodiment 52, wherein the action may be any of a device action, a device setting update, a software update.
54. The method of embodiment 52, wherein the key server is an OEM key server.
55. The method of embodiment 52, wherein a device associated by device ID is a vehicle.
56. The method of embodiment 55, wherein said smart key is further configured to pass usage information from said vehicle via a mobile phone to a smart key server for data analysis.
57. The method of embodiment 55, wherein said smart key is further configured to pass usage information to said vehicle via a mobile phone to a smart key server.
58. The method of embodiment 55, wherein said smart key is further configured to pass a software update to said vehicle via a mobile phone from a smart key server.
59. The method of embodiment 55, wherein a second device associated by device IP is a second vehicle.
60. The method of embodiment 59, wherein said smart key apparatus serves as a conduit to transfer settings used for a first vehicle to a second vehicle.
61. The method of embodiment 52 wherein a passcode used within said smart key secure element component is an alphanumeric value.
62. The method of embodiment 52 wherein a passcode used within said smart key secure element component is an audible code.
63. The method of embodiment 52 wherein a passcode used within said smart key secure element component is a biometric.
64. The method of embodiment 63 wherein a passcode used within said biometric is a fingerprint.
65. The method of embodiment 52 wherein a passcode used within said smart key secure element component is encrypted.
66. The method of embodiment 52 wherein the deviceID is registered with an OEM.
67. The method of embodiment 66 further configured to receive method mapping from said OEM for device activities to the smart key fob component.
68. The method of embodiment 67 wherein said method mapping comprises instructions for an opentrunk operation by OEM maps to open a vehicle trunk upon activation of a button on the keyfob.
69. A method of integrating a key fab in vehicle functionality and data analysis, comprising:
instantiating a component collection in said key fab and being operatively associated with a processor of a first vehicle processor and a data analytics server, and configured to transit data via a mobile phone to said data analytics server, the component collection comprising:
   an application identifier (ID) component,
      user ID component,
      an original equipment manufacturer (OEM) ID component,
      a device ID, wherein the device ID is a device associated with the smart key,
      a smart key secure element component having a unique value, wherein the secure element may be used to generate any of: encryption keys, encrypted data, secure tokens, and passcodes;
      a smart key fob component, wherein the smart key fob may subsume previous components;
transmitting data to and from said first vehicle processor to said data analytics server via said mobile phone.
70. The method of embodiment 69 further comprising:
transmitting data to and from a second vehicle processor to said data analytics server via a mobile phone.
71. The method of embodiment 70 wherein settings for a first vehicle can be applied to a second vehicle via said key fab and a mobile phone.
72. The method of embodiment 70 wherein settings for a first vehicle can be adapted to a second vehicle via said key fab and a mobile phone.
73. The method of embodiment 69, wherein data transmitted to the vehicle is used to execute an action which may be any of a device action, a device setting update, a software update.
74. The method of embodiment 69, wherein the key server is an OEM key server.
75. The method of embodiment 69, wherein said smart key is further configured to pass a software update to said vehicle via a mobile phone from a smart key server.
76. The method of embodiment 69 wherein a passcode used within said smart key secure element component is an alphanumeric value.
77. The method of embodiment 69 wherein a passcode used within said smart key secure element component is an audible code.
78. The method of embodiment 69 wherein a passcode used within said smart key secure element component is a biometric.
79. The method of embodiment 69 wherein a passcode used within said biometric is a fingerprint.
80. The method of embodiment 69 wherein a passcode used within said smart key secure element component is encrypted.
81. The method of embodiment 69 wherein the deviceID is registered with an OEM.
82. The method of embodiment 69 further receiving method mapping data from an OEM for device activities to the smart key fob component.
83. The method of embodiment 82 wherein said method mapping data comprises instructions for an opentrunk operation by OEM maps to open a vehicle trunk upon activation of a button on the keyfob.
84. A method of using a keyfob to transfer desired settings from one vehicle to a second vehicle, comprising:
instantiating a series of instruction components in said keyfob to facilitate communication with a settings server and a first locked device processor;
initiating communication with said first automotive processor to transfer desired settings via a mobile phone and said keyfob to said first locked device processor;
receiving usage data from said first locked device processor;
transmitting said usage data to said settings server via said mobile phone;
initiating communication with a second locked device processor to transfer desired settings via a mobile phone and said keyfob to said locked device automotive processor;
receiving additional usage data from said locked device automotive processor;
transmitting said additional usage data to said settings server via said mobile phone; and
analyze said usage data and said additional usage data to alter said desired settings.
85. The method of embodiment 84 wherein said locked device is any of: transportation device, a dwelling, a locking mechanism.
86. The method of embodiment 84 wherein said key fob communicates with said mobile phone via Bluetooth.
87. The method of embodiment 84 wherein said key fob communicates with said mobile phone via wifi.
88. The method of embodiment 84 wherein said key fob communicates with said mobile phone via wired connection.
89. The method of embodiment 84 wherein said key fob communicates with either vehicle processor via Bluetooth.
90. The method of embodiment 84 wherein said key fob communicates with either vehicle processor via wifi.
91. The method of embodiment 84 wherein said key fob communicates with either vehicle processor via RF.
92. The method of embodiment 84 wherein said key fob communicates with either vehicle processor via wired connection.
93. The method of embodiment 84 wherein said keyfab initiates an unlocking process to unlock an automobile car door, as said keyfab comes in proximity to the vehicle.
94. The method of embodiment 89 wherein said unlocking process comprises:
establishing wireless communication between said keyfob and said first automotive processor to initiate said unlocking process;
establishing communication between said keyfob and said settings server via said mobile phone to receive an unlocking code; and
transmitting an unlocking code from said keyfob to said first automotive processor to request entry to a first vehicle.
95. The method of embodiment 94 wherein said unlocking process further comprises:
establishing wireless communication between said first automotive processor and said settings server via wireless communication with said keyfob and said mobile phone.
96. A method of using a keyfob to transfer desired settings from one device to a second device, comprising:
instantiating a series of instruction components in said keyfob to facilitate communication with a settings server and a first device processor;
initiating communication with said first locked device processor to transfer desired settings via a mobile phone and said keyfob to said first device processor;
receiving usage data from said first device processor;
transmitting said usage data to said settings server via said mobile phone;
initiating communication with a second device processor to transfer desired settings via a mobile phone and said keyfob to said second device processor;
receiving additional usage data from said second device processor;
transmitting said additional usage data to said settings server via said mobile phone; and
analyze said usage data and said additional usage data to alter said desired settings.
97. The method of embodiment 96 wherein said locked device is any of: transportation device, a dwelling, a locking mechanism.
98. The method of embodiment 96 wherein said key fob communicates with said mobile phone via Bluetooth.
99. The method of embodiment 96 wherein said key fob communicates with said mobile phone via wifi.
100. The method of embodiment 96 wherein said key fob communicates with said mobile phone via wired connection.
101. The method of embodiment 96 wherein said key fob communicates with either device processor via Bluetooth.
102. The method of embodiment 96 wherein said key fob communicates with either device processor via wifi.
103. The method of embodiment 96 wherein said key fob communicates with either device processor via RF.
104. The method of embodiment 96 wherein said key fob communicates with either device processor via wired connection.
105. The method of embodiment 96 wherein said device is a vehicle, and wherein said keyfab initiates an unlocking process to unlock an automobile car door, as said keyfab comes in proximity to the vehicle.
106. The method of embodiment 105 wherein said unlocking process comprises:
establishing wireless communication between said keyfob and said first device processor to initiate said unlocking process;
establishing communication between said keyfob and said settings server via said mobile phone to receive an unlocking code; and
transmitting an unlocking code from said keyfob to said first device processor to request entry to a first vehicle.
107. The method of embodiment 106 wherein said unlocking process further comprises: establishing wireless communication between said first device processor and said settings server via wireless communication with said keyfob and said mobile phone.

In order to address various issues and advance the art, the entirety of this application for SmartKey Apparatuses, Methods and Systems (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached,” “affixed,” “connected,” “coupled,” “interconnected,” and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a SmartKey individual and/or enterprise user, database configuration and/or relational model, data type, data transmission and/or network framework, syntax structure, and/or the like, various embodiments of the SmartKey, may be implemented that enable a great deal of flexibility and customization. For example, aspects of the SmartKey may be adapted for automobiles, consumer devices, locks, network devices, etc. While various embodiments and discussions of the SmartKey have included locking devices, however, it is to be understood that the embodiments described herein may be readily configured and/or customized for a wide variety of other applications and/or implementations.

What is claimed is:

1. A smart key apparatus, comprising:
a smart key housing containing:
a memory;
a component collection in the memory, including:
an application identifier (ID) component,
user ID component,
an original equipment manufacturer (OEM) ID component,
a device ID, wherein the device ID is a device associated with the smart key,
a smart key secure element component having a unique value, wherein the secure element may be used to generate any of: encryption keys, encrypted data, secure tokens, and passcodes;
a smart key fob component, wherein the smart key fob may subsume previous components;
a processor disposed in communication with the memory, and configured to issue a plurality of processing instructions from the component collection stored in the memory,
wherein the processor issues instructions from the smart key fob component, stored in the memory, to:
register a user ID component with a key server;
register a application ID component with a key server;
generate a passcode for action at a device referenced by the device ID;
provide an action to the device referenced by the device ID;
a touch screen disposed in communication with the processor for display of smart key interaction with devices associated by device ID;
a sensor array disposed in communication with the processor;
at least one programmable context aware engageable input indicator disposed in communication with the processor;
a connector disposed in communication with the processor and configured to communicate with outside devices, and
a transceiver disposed in communication with the processor.

2. The apparatus of claim 1, wherein the action may be any of a device action, a device setting update, a software update.

3. The apparatus of claim 1, wherein the key server is an OEM key server.

4. The apparatus of claim 1, wherein a device associated by device ID is a vehicle.

5. The apparatus of claim 4, wherein said smart key apparatus is further configured to pass usage information from said vehicle via a mobile phone to a smart key server for data analysis.

6. The apparatus of claim 4, wherein said smart key apparatus is further configured to pass usage information to said vehicle via a mobile phone to a smart key server.

7. The apparatus of claim 4, wherein said smart key apparatus is further configured to pass a software update to said vehicle via a mobile phone from a smart key server.

8. The apparatus of claim 4, wherein a second device associated by device IP is a second vehicle.

9. The apparatus of claim 8, wherein said smart key apparatus serves as a conduit to transfer settings used for a first vehicle to a second vehicle.

10. The apparatus of claim 1 wherein a passcode used within said smart key secure element component is an alphanumeric value.

11. The apparatus of claim 1 wherein a passcode used within said smart key secure element component is an audible code.

12. The apparatus of claim 1 wherein a passcode used within said smart key secure element component is a biometric.

13. The apparatus of claim 12 wherein a passcode used within said biometric is a fingerprint.

14. The apparatus of claim 1 wherein a passcode used within said smart key secure element component is encrypted.

15. The apparatus of claim 1 wherein the deviceID is registered with an OEM.

16. The apparatus of claim 15 further configured to receive method mapping from said OEM for device activities to the smart key fob component.

17. The apparatus of claim 16 wherein said method mapping comprises instructions for an opentrunk function by OEM maps to open a vehicle trunk upon activation of a button on the keyfob.

18. A processor-readable smart key non-transient medium storing processor-executable components, the components, comprising:
a component collection stored in the medium, including:
an application identifier (ID) component,
user ID component,
an original equipment manufacturer (OEM) ID component,
a device ID, wherein the device ID is a device associated with the smart key,
a smart key secure element component having a unique value, wherein the secure element may be used to generate any of: encryption keys, encrypted data, secure tokens, and passcodes;
a smart key fob component, wherein the smart key fob may subsume previous components;
wherein said smart key fob component collection provides instructions to a processor to:
register a user ID component with a key server;
register a application ID component with a key server;
generate a passcode for action at a device referenced by the device ID;
provide an action to the device referenced by the device ID; and
wherein said smart key fob component provides instructions to a touch screen disposed in communication with the processor for display of smart key interaction with devices associated by device ID.

19. A processor-implemented smart key system, comprising:
a smart key means for housing:
a memory;
a component collection in the memory, including:
an application identifier (ID) component,
user ID component,
an original equipment manufacturer (OEM) ID component,
a device ID, wherein the device ID is a device associated with the smart key,
a smart key secure element component having a unique value, wherein the secure element may be used to generate any of: encryption keys, encrypted data, secure tokens, and passcodes;
a smart key fob component, wherein the smart key fob may subsume previous components;
a processor means disposed in communication with the memory for issuing a plurality of processing instructions from the component collection stored in the memory,
wherein the processor means issues instructions from the smart key fob component, stored in the memory, to:
register a user ID component with a key server;
register a application ID component with a key server;
generate a passcode for action at a device referenced by the device ID;
provide an action to the device referenced by the device ID;
a touch screen means disposed in communication with the processor for displaying smart key interaction with devices associated by device ID;
a sensor array means disposed in communication with the processor;
at least one programmable context aware engageable input indicator means disposed in communication with the processor;
a connector means disposed in communication with the processor and configured for communicating with outside devices, and
a transceiver means disposed in communication with the processor.

20. A method for using a smart key for device analytics and control, comprising:
registering a user ID component of a smart key with a key server;
registering an application ID component of a smart key with a key server;
generating a passcode for action at a device referenced by a device ID;
providing an action to the device referenced by the device ID;
wherein said smart key contains:
a memory;
a component collection in the memory, including:
an application identifier (ID) component,
user ID component,
an original equipment manufacturer (OEM) ID component,
a device ID, wherein the device ID is a device associated with the smart key,
a smart key secure element component having a unique value, wherein the secure element may be used to generate any of: encryption keys, encrypted data, secure tokens, and passcodes;
a smart key fob component, wherein the smart key fob may subsume previous components;
and further wherein:
a touch screen is disposed in communication with the smart key for display of smart key interaction with devices associated by device ID;
a sensor array is disposed in communication with the smart key;
at least one programmable context aware engageable input indicator is disposed in communication with the processor;
a connector is disposed in communication with the processor and configured to communicate with outside devices, and
a transceiver is disposed in communication with the processor.

21. A method of integrating a key fab in vehicle functionality and data analysis, comprising: instantiating a component collection in said key fab and being operatively associated with a processor of a first vehicle processor and a data analytics server, and configured to transit data via a mobile phone to said data analytics server, the component collection comprising:
an application identifier (ID) component,
user ID component,
an original equipment manufacturer (OEM) ID component,
a device ID, wherein the device ID is a device associated with the smart key,
a smart key secure element component having a unique value, wherein the secure element may be used to generate any of: encryption keys, encrypted data, secure tokens, and passcodes;
a smart key fob component, wherein the smart key fob may subsume previous components;
transmitting data to and from said first vehicle processor to said data analytics server via said mobile phone.
